(19) United States
(12) Patent Application Publication
(10) Pub. No.: US 2018/0363860 A1
(43) Pub. Date: Dec. 20, 2018

(54) LIGHT SOURCE DEVICE

(71) Applicant: PANASONIC INTELLECTUAL PROPERTY MANAGEMENT CO., LTD., Osaka (JP)

(72) Inventors: Hideki KASUGAI, Shiga (JP); Masaharu FUKAKUSA, Osaka (JP); Toshihiro KOGA, Osaka (JP); Yoshihisa NAGASAKI, Osaka (JP); Kazuhiko YAMANAKA, Osaka (JP)

(21) Appl. No.: 16/112,162

(22) Filed: Aug. 24, 2018

Related U.S. Application Data
(63) Continuation of application No. PCT/JP2017/008659, filed on Mar. 6, 2017.

(30) Foreign Application Priority Data
Mar. 8, 2016 (JP) 2016-045036

(51) Int. Cl. F21K 9/64; F21K 9/68; F21S 41/67; F21S 41/16

(52) U.S. Cl. CPC F21K 9/64; F21S 41/16; F21S 41/67; F21K 9/68

(57) ABSTRACT

A light source device includes: a semiconductor light-emitting element; a converging optical system which converges the excitation light emitted from the semiconductor light-emitting element; and a wavelength conversion element to which the excitation light is emitted. The wavelength conversion element includes: a first wavelength conversion region where main light enters; and a second wavelength conversion region which is disposed in the surrounding region of the first wavelength conversion region and where the excitation light excluding the main light enters. The wavelength conversion efficiency in the second wavelength conversion region is lower than the wavelength conversion efficiency in the first wavelength conversion region.

### CROSS REFERENCE TO RELATED APPLICATIONS

This application is a U.S. continuation application of PCT International Patent Application Number PCT/JP2017/008659 filed on Mar. 6, 2017, claiming the benefit of priority of Japanese Patent Application Number 2016-045036 filed on Mar. 8, 2018, the entire contents of which are hereby incorporated by reference.

### BACKGROUND

### 1. Technical Field

The present disclosure relates to a light source device.

### 2. Description of the Related Art

Conventionally, a light source device has been proposed which uses, as illumination light, mixed light of both excitation light and fluorescence generated by emitting excitation light to a phosphor (for example, Japanese Unexamined Patent Application Publication No. 2012-99280 and Japanese Unexamined Patent Application Publication No. 2011-181381).

This type of light source device will be described with reference to FIG. 24. FIG. 24 schematically illustrates a schematic configuration of conventional light source device 1001. As illustrated in FIG. 24, light source device 1001 includes: laser elements 1002 which emit excitation light; light emitter 1004 which emits fluorescence upon reception of the excitation light emitted from laser elements 1002; and reflective mirror 1005 which reflects the fluorescence generated by light emitter 1004. A portion of reflective mirror 1005 is disposed opposite to and above light emitter 1004. Here, it is disclosed that the area of the spot of the excitation light emitted to the upper surface of light emitter 1004 is smaller than the area of the upper surface.

In contrast, the light source device disclosed in Japanese Unexamined Patent Application Publication No. 2011-181381 includes a laser element and a phosphor layer. Japanese Unexamined Patent Application Publication No. 2011-181381 discloses that the shape and the cross-sectional area of the beam of the excitation light emitted from the laser element and entering the phosphor layer is approximately equal to the shape and the area of the entire surface of the phosphor layer where light enters. In the conventional example, an absorber which absorbs the excitation light from the laser element, or a diffuser which diffuses the excitation light is further disposed around the phosphor layer.

### SUMMARY

However, the conventional light source devices have the following problems.

A laser element, such as a semiconductor laser, emits stimulated emission light with directivity. The stimulated emission light is emitted to the light emitter as main light. However, the laser element may emit simulated emission light from the portion other than its light emitter, even though it is weak. Moreover, the laser element emits spontaneous emission light with no directivity. Moreover, when the excitation. light emitted from the laser element is converged by a converging optical system, scattered light may be generated by the stimulated emission light being scattered by dust and the like adhered to the converging optical system. This auxiliary light may also be emitted to the light emitter.

Hence, as disclosed in Japanese Unexamined Patent Application Publication No. 2012-99280, when the excitation light from laser elements 1002 is converged by the converging optical system, and when the converged main light is emitted to light emitter 1004, the auxiliary light is emitted to the surrounding region of the region to which the main light is emitted. Hence, light emitter 1004 emits not only the fluorescence generated by the main light but also the fluorescence generated by the auxiliary light. Accordingly, when light from light emitter 1004 is projected by a light projecting member such as a reflective mirror, the fluorescence generated by the auxiliary light is also projected.

Hence, a problem occurs in which light from the light source device is projected as stray light onto the region other than a desired projection region.

In contrast, in the light source device disclosed in Japanese Unexamined Patent Application Publication No. 2011-181381, auxiliary light other than the main light does not enter the phosphor layer, but is absorbed by the absorber. Accordingly, generation of stray light can be reduced.

However, when the position of the converging optical system changes due to an impact made during the operation or a temperature change in the light source device, and the main light is emitted not to the phosphor layer but to the absorber, almost the entire main light is absorbed by the absorber.

In this case, almost no light is emitted from the light source device. Therefore, as an example, in the case where the light source device is used for, for example, a vehicle headlamp, such a problem can occur in which the front visibility is suddenly eliminated due to stoppage of light emitted from the light source device.

Accordingly, an object of the present disclosure is to reduce, in a light source device including a semiconductor light-emitting element, a converging optical system, and a wavelength conversion element, outgoing light generated by the excitation light emitted from the semiconductor light-emitting element and excluding the main light converged by the converging optical system. Moreover, another object of the present disclosure is to provide a light source device capable of emitting light even when the optical axis of the main light emitted from the semiconductor light-emitting element and the converging optical system is displaced.

In order to achieve the above objects, an aspect of the light source device according to the present disclosure is a light source device which includes: a semiconductor light-emitting element; a converging optical system which converges excitation light emitted from the semiconductor light-emitting element; and a wavelength conversion element which includes a wavelength converter to which the excitation light is emitted, the wavelength converter converting at least a portion of a wavelength of the excitation light and emitting light having a converted wavelength. The wavelength conversion element includes: a first wavelength conversion region which includes a portion of the wavelength converter, and where main light of the excitation light enters, the main light being converged by the converging optical system; and a second wavelength conversion region (i) which includes a portion of the wavelength converter other than the portion of the wavelength converter in the first wavelength conversion region, (ii) which is disposed in a surrounding region of the first wavelength conversion region, and (iii) where the excitation light excluding the main light enters, and the second wavelength conversion region has a wavelength conversion efficiency lower than a wavelength conversion efficiency of the first wavelength conversion region.

With this configuration, among the excitation light coming from the converging optical system and entering the wavelength conversion element, the excitation light excluding the main light enters the second wavelength conversion region having a lower wavelength conversion efficiency. Accordingly, it is possible to reduce outgoing light which is generated by the excitation light excluding the main light and which is emitted from light source device 100. Moreover, with the above configuration, even when the optical axis of the main light is displaced, the main light enters the second wavelength conversion region, and thus, the light source device is capable of emitting outgoing light generated by the main light. Thus, for example, in the case where the light source device is used for a vehicle headlamp, even when the optical axis is displaced, it is possible to reduce the case where no light is emitted from the light source device, ensuring visibility in the light projection region.

Moreover, according to another aspect of the light source device in the present disclosure, it may be that the wavelength converter includes a phosphor material activated by a rare earth element, and the phosphor material absorbs at least a portion of the excitation light, and emits fluorescence as the light having the converted wavelength, the fluorescence having a wavelength different from the wavelength of the excitation light.

With this configuration, white light can be emitted by using, for example, blue light as excitation light and a yellow phosphor as a phosphor material.

Moreover, according to another aspect of the light source device in the present disclosure, it may be that a thickness of the wavelength converter less in the second wavelength conversion region than in the first wavelength conversion region.

With this configuration, it is possible to reduce, in the first wavelength conversion region, the excitation light emitted from the wavelength converter without wavelength conversion, compared to the second wavelength conversion region. Accordingly, it is possible to realize the first wavelength conversion region having a wavelength conversion efficiency higher than the wavelength conversion efficiency in the second wavelength conversion region.

Moreover, according to another aspect of the light source device in the present disclosure, it may be that the wavelength conversion element includes a light attenuator which reduces an amount of light emitted from the second wavelength conversion region.

With this configuration, since the amount of outgoing light can be reduced by the light attenuator, it is possible to realize the second wavelength conversion region having a wavelength conversion efficiency lower than the wavelength conversion efficiency in the first wavelength conversion region.

Moreover, according to another aspect of the light source device in the present disclosure, it may be that the light attenuator transmits the excitation light, and reflects the light emitted from the wavelength converter and having the converted wavelength.

With this configuration, the amount of the wavelength-converted light emitted from the second wavelength conversion region can be reduced, and thus, the wavelength conversion efficiency in the second wavelength conversion region can be reduced. Moreover, this configuration can be easily realized by, for example, a dielectric multilayer.

Moreover, according to another aspect of the light source device in the present disclosure, it may be that the light attenuator absorbs at least one of the excitation light or the light emitted from the wavelength converter to convert the absorbed light into heat.

With this configuration, the light attenuator absorbs the excitation light or wavelength-converted light, and thus, the wavelength conversion efficiency in the second wavelength conversion region can be reduced. Moreover, this configuration can be easily realized by, for example, a metal film of Au, Cu or the like, polysilicon, or a metal silicide such as SiW or SiTi.

Moreover, according to another aspect of the light source device in the present disclosure, it may be that the light attenuator includes an opening at a position corresponding to the first wavelength conversion region.

With this configuration, it is possible to reduce the case where the main light enters the light attenuator. Accordingly, the light attenuator can reduce the reduction of the wavelength conversion efficiency in the first wavelength conversion region.

Moreover, according to another aspect of the light source device in the present disclosure, it may be that the opening has a diameter greater than or equal to a spot diameter of the main light on a surface of the wavelength converter where the main light enters.

With this configuration, it is possible to reduce entrance of the high-intensity portion of the main light into the light attenuator by causing the main light to enter the center of the opening of the light attenuator. Accordingly, the light attenuator can reduce the reduction of the wavelength conversion efficiency in the first wavelength conversion region.

Moreover, according to another aspect of the light source device in the present disclosure, it may be that the wavelength conversion element includes a support member having a recess, and the wavelength converter is disposed in the recess and in a surrounding region of the recess.

With this configuration, for example, the wavelength converter can be formed by applying a wavelength conversion material to the recess of the support material and the surrounding region of the recess. Here, the wavelength converter formed in the surrounding region of the recess is thinner than the wavelength converter formed in the recess. In other words, the wavelength converter formed in the recess forms the first wavelength conversion region and the wavelength converter formed in the surrounding region of the recess forms the second wavelength conversion region. With this configuration, it is possible to easily realize the wavelength conversion element which includes the first wavelength conversion region and the second wavelength conversion region.

Moreover, according to another aspect of the light source device in the present disclosure, it may be that a surface of a portion of the wavelength converter disposed in the recess is recessed.

With this configuration, outgoing light can be converged by causing the main light to enter the surface of the wavelength converter disposed in the recess. In other words, the wavelength converter having such a configuration can emit light having a higher directivity than a wavelength converter having a flat surface does.

Moreover, according to another aspect of the light source device in the present disclosure, it may be that the main light enters the wavelength converter obliquely relative to a surface of the wavelength converter and the wavelength conversion element includes, in the second wavelength conversion region, a projection to which the main light reflected by the surface is emitted.

With this configuration, reflected light having a high directivity can be scattered. Accordingly, it is possible to reduce the case where the reflected light is emitted from the light source device while maintaining a high directivity.

According to the present disclosure, in a light source device which includes a semiconductor light-emitting element, a converging optical system, and a wavelength conversion element, it is possible to reduce outgoing light generated by the excitation light emitted from the semiconductor light-emitting element and the converging optical system and excluding the main light. Moreover, according to the present disclosure, even when the optical axis of the main light emitted from the semiconductor light-emitting element and the converging optical system is displaced, outgoing light can be emitted.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a cross-sectional view of a configuration of a light source device according to Embodiment 1;

FIG. 2A is a perspective view of a schematic configuration of a semiconductor light-emitting element according to Embodiment 1;

FIG. 2B is a cross-sectional view of a schematic configuration of the semiconductor light-emitting element according to Embodiment 1;

FIG. 3A is a schematic cross-sectional view of a schematic configuration of a wavelength conversion element according to Embodiment 1;

FIG. 3B is a schematic top view of the schematic configuration of the wavelength conversion element according to Embodiment 1;

FIG. 4 is a cross-sectional view of an example of an operation of a converging optical system according to Embodiment 1 on excitation light when an aspherical convex lens is used as the converging optical system;

FIG. 5A schematically illustrates a projection image obtained when the light source device according to Embodiment 1 operates in combination with a light projecting member;

FIG. 5B schematically illustrates a projection image obtained when a light source device according to a comparative example operates in combination with a light projecting member;

FIG. 6 is a cross-sectional view of a specific configuration of the light source device according to Embodiment 1;

FIG. 7A illustrates a luminance distribution, measured using an optical system equivalent to the light source device according to Embodiment 1 illustrated in FIG. 6 and a wavelength conversion element which does not include a light attenuator, of outgoing light emitted by emitting main light and auxiliary light to the surface corresponding to the surface of the wavelength conversion element;

FIG. 7B illustrates graphs which indicate the luminance distributions along line VIIB-VIIB of the luminance distribution illustrated in FIG. 7A, and compare the luminance distributions of different wavelength conversion elements and different converging optical systems;

FIG. 8 is a cross-sectional view of an example of a positional displacement of the converging optical system in the light source device according to Embodiment 1;

FIG. 9A is a schematic cross-sectional view of a schematic configuration of a wavelength conversion element according to Variation 1 of Embodiment 1;

FIG. 9B is a schematic top view of the schematic configuration of the wavelength conversion element according to Variation 1 of Embodiment 1;

FIG. 10 is a schematic diagram illustrating each step of a method for manufacturing the wavelength conversion element according to Variation 1 of Embodiment 1;

FIG. 11A is a schematic diagram illustrating an optical path of reflected light of main light on the wavelength conversion element according to Variation 1 of Embodiment 1;

FIG. 11B is a schematic diagram illustrating an optical path of reflected light of the an light on the wavelength conversion element according to Embodiment 1;

FIG. 12A is a schematic cross-sectional view of a schematic configuration of a wavelength conversion element according to Embodiment 2;

FIG. 12B is a schematic top view of the schematic configuration of the wavelength conversion element according to Embodiment 2;

FIG. 13 is a schematic diagram illustrating each step of a method for manufacturing the wavelength conversion element according to Embodiment 2;

FIG. 14 is a cross-sectional view of a specific configuration of a light source device according to Embodiment 2;

FIG. 15 is a schematic cross-sectional view of a schematic configuration of a wavelength conversion element according to Variation 1 of Embodiment 2;

FIG. 16A is a schematic cross-sectional view of a schematic configuration of a wavelength conversion element according to Embodiment 3;

FIG. 16B is a cross-sectional view of a specific configuration of a light source device according to Embodiment 3;

FIG. 17 is a schematic cross-sectional view of a schematic configuration of a wavelength conversion element according to Embodiment 4;

FIG. 18 is a cross-sectional view illustrating each step of a method for manufacturing the wavelength conversion element according to Embodiment 4;

FIG. 19 is a schematic diagram illustrating an operation of the wavelength conversion element according to Embodiment 4;

FIG. 20 is a schematic cross-sectional view of a schematic configuration of a wavelength conversion element according to Variation 1 of Embodiment 4;

FIG. 21 is a cross-sectional view of a configuration of a light source device according to Embodiment 5;

FIG. 22 is a schematic cross-sectional view of a detailed configuration of a wavelength conversion element mounted in the light source device according to Embodiment 5;

FIG. 23 illustrates characteristic evaluation results indicating the effects of the wavelength conversion element mounted in the light source device according to Embodiment 5; and

FIG. 24 schematically illustrates a schematic configuration of a conventional light source device.

### DETAILED DESCRIPTION OF THE EMBODIMENTS

Embodiments according to the present disclosure will be described below with reference to the drawings. Note that, the embodiments described below each indicate one specific example of the present disclosure. Accordingly, the values, structural elements, arrangement and connection of the structural elements, processes (steps) and the order of the processes and the like described in the embodiments below are examples, but are not intended to limit the present disclosure. Therefore, among the structural elements in the following embodiments, structural elements which are not recited in the independent claims defining the most generic concept of the present disclosure are described as optional structural elements.

### Embodiment 1

### 1-1. Configuration

Hereinafter, a light source device according to Embodiment 1 will be described with reference to the drawings.

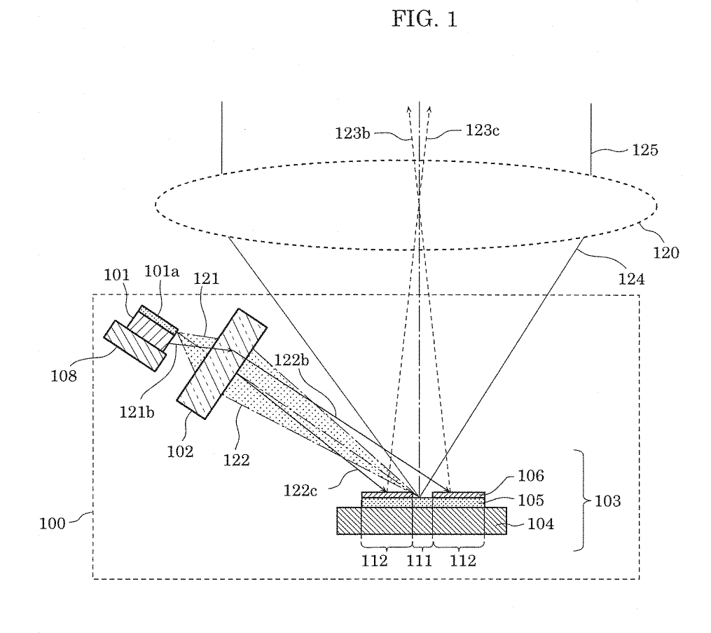

FIG. 1 is a cross-sectional view of a configuration of light source device 100 according to the present embodiment.

As illustrated in FIG. 1, light source device 100 according to the present embodiment is a light source which includes semiconductor light-emitting element 101, converging optical system 102, and wavelength conversion element 103.

Hereinafter, each structural element of light source device 100 will be described.

### 1-1-1. Semiconductor Light-Emitting Element

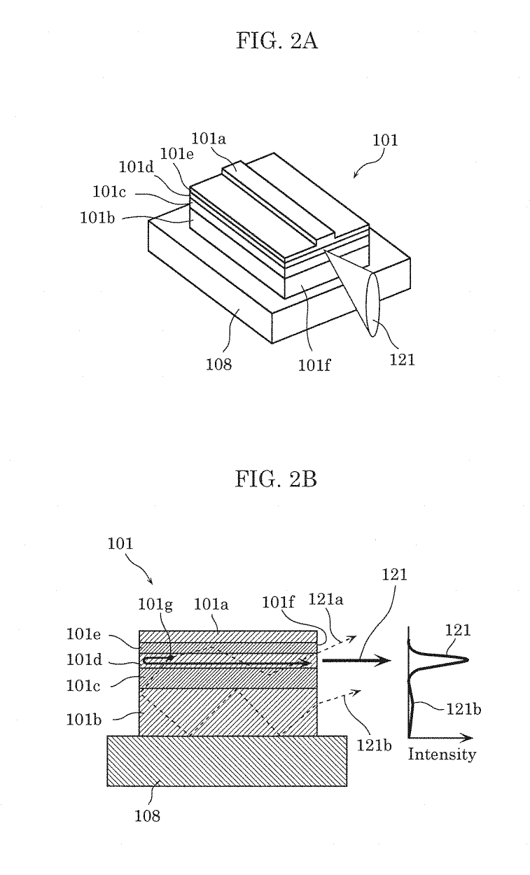

Semiconductor light-emitting element 101 is a light-emitting element which emits excitation light. Hereinafter, semiconductor light-emitting element 101 will be described with reference to FIG. 1, FIG. 2A, and FIG. 2B.

FIG. 2A is a perspective view of a schematic configuration of semiconductor light-emitting element 101 according to the present embodiment.

FIG. 2B is a cross-sectional view of a schematic configuration of semiconductor light emitting element 101 according to the present embodiment.

Semiconductor light-emitting element 101 is a semiconductor laser element (for example, a laser chip) made of, for example, a nitride semiconductor, and emits, as excitation light 121, laser light having a peak wavelength between 380 nm and 490 nm. As illustrated in FIG. 1, FIG. 2A and FIG. 2B, in the present embodiment, semiconductor light-emitting element 101 is mounted on support member 108 such as a silicon carbide substrate.

As illustrated in FIG. 2A and FIG. 2B, semiconductor light-emitting element 101 has a configuration in which, for example, first clad 101c made of n-type AlGaN, light-emitting layer 101d which is an InGaN multiple quantum well layer, and second clad 101e made of p-type AlGaN are stacked on substrate 101b which is a GaN substrate. Moreover, semiconductor light-emitting element 101 includes optical waveguide 101a.

Semiconductor light-emitting element 101 receives electrical power supply from outside light source device 100. The laser light having, for example, a peak wavelength of 445 nm generated by optical waveguide 101a of semiconductor light-emitting element 101 is emitted as excitation light 121 toward converging optical system 102.

### 1-1-2. Converging Optical System

Converging optical system 102 is an optical system which converges the excitation light emitted from semiconductor light-emitting element 101. The configuration of converging optical system 102 is not particularly limited as long as excitation light 121 can be converged. For example, an aspherical convex lens can be used as converging optical system 102. Converging optical system 102 converges excitation light 121 emitted from semiconductor light-emitting element 101 and having a radiation angle in the horizontal and vertical directions, and generates main light 122. Main light 122 is emitted to wavelength conversion element 103. As illustrated in FIG. 1, in the present embodiment, main light 122 is emitted to wavelength conversion element 103 from obliquely above wavelength conversion element 103. Specifically, main light 122 enters wavelength conversion element 103 at an angle of 40° or greater and 80° or less relative to the surface normal of wavelength conversion element 103.

### 1-1-3. Wavelength Conversion Element

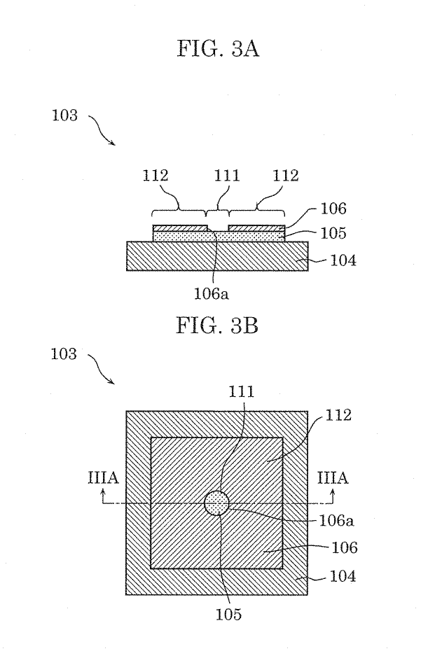

Wavelength conversion element 103 is an element to which excitation light 121 is emitted, which converts at least a portion of the wavelength of excitation light 121, and emits light having a converted wavelength. Hereinafter, wavelength conversion element 103 will be described with reference to FIG. 1, FIG. 3A, and FIG. 3B.

FIG. 3A is a schematic cross-sectional view of a schematic configuration of wavelength conversion element 103 according to the present embodiment.

FIG. 3B is a schematic top view of the schematic configuration of wavelength conversion element 103 according to the present embodiment. Note that FIG. 3A illustrates a cross-section taken along IIIA-IIIA in FIG. 3B.

As illustrated in FIG. 1, wavelength conversion element 103 is an element which includes wavelength converter 105 to which excitation light 121 emitted from semiconductor light-emitting element 101 is emitted, which converts at least a portion of the wavelength of excitation light 121, and emits light having a converted wavelength. As illustrated in FIG. 3A and FIG. 3B, wavelength conversion element 103 includes first wavelength conversion region 111 which includes a portion of wavelength converter 105, and where main light 122, which is converged by converging optical system 102, of excitation light 121 enters. Moreover, wavelength conversion element 103 includes second wavelength conversion region 112 (i) which includes a portion of wavelength converter 105 other than the above portion of wavelength converter 105 in first wavelength conversion region 111, (ii) which is disposed in the surrounding region of first wavelength conversion region 111, and (iii) where excitation light 121 excluding main light 122 enters. Here, the wavelength conversion efficiency is lower in second wavelength conversion region 112 than in first wavelength conversion region 111.

In the present embodiment, as illustrated in FIG. 3A and FIG. 3B, wavelength conversion element 103 includes support member 104, wavelength converter 105, and light attenuator 106.

Wavelength converter 105 includes a phosphor material activated by, for example, rare earth elements. The phosphor material absorbs at least a portion of excitation light 121, and emits fluorescence having a wavelength different from the wavelength of excitation light 121, as wavelength-converted light.

Wavelength converter 105 includes, for example, a phosphor material and a binder for holding the phosphor material. As the phosphor material, for example, aluminate-based phosphor (for example, Ce-activated garnet-based phosphor represented by YAG:Ce³⁺, (Y, Gd, Lu)₃(Al, Ga)₅O₁₂:Ce or the like), oxynitride-based phosphor (for example, β.SiAlON:Eu²⁺, Ca.α.SiAlON:Eu²⁺, or (Ca, Sr, Ba) SiO₂N₂:Eu²⁺), nitride phosphor (for example, (Sr, Ca) AlSiN₃:Eu²⁺, or (La, Y, Gd)₃Si₆N₁₁:Ce³⁺), silicate-based phosphor (for example, Sr₃MgSi₂O₈:Eu²⁺, or (Ba, Sr, Mg)₂SiO₄:Eu²⁺), phosphate-based phosphor (for example, Sr(PO₄)₃Cl:Eu²⁺), or quantum dot phosphor (nanoparticles of InP, CdSe or the like) can be used. Moreover, wavelength converter 105 may include, in addition to the phosphor material, a diffusion material which diffuses (scatters) main light 122. As the diffusion material, fine particles of, for example, SiO₂, Al₂O₃, ZnO, or TiO₂ can be used. Moreover, the light scattering property of wavelength converter 105 can be enhanced and heat from the phosphor material can be efficiently transferred to the support member, by mixing the fine particles of boron nitride having a high thermal conductivity as a diffusion material to wavelength converter 105.

Here, light source device 100 can emit light having desired chromaticity coordinates, by selecting a phosphor which emits desired fluorescence. For example, green light, yellow light, or red light can be emitted. Moreover, light source device 100 can emit white light by configuring wavelength converter 105 with a combination of a plurality of phosphors or by combining the chromaticity coordinates of the fluorescence emitted from wavelength converter 105 and the chromaticity coordinates of the excitation light reflected by wavelength converter 105. For example, when semiconductor light-emitting element 101 which emits excitation light having a peak wavelength of 405 nm is used, white light can be obtained by using, as phosphor materials, a combination of Sr(PO₄)₃Cl:Eu²⁺ which is a blue phosphor and YAG:Ce³⁺ which is a yellow phosphor. Moreover, for example, when a semiconductor light-emitting element which emits blue excitation light having a peak wavelength of 445 nm is used, diffused blue light and yellow light can be mixed and white light can be obtained by using, as a phosphor material, YAG:Ce³⁺ or (La, Y)₃Si₆N₁₁:Ce³⁺ which are yellow phosphors. As a binder for holding the phosphor material, for example, a highly heat resistant silicone resin or organic-inorganic hybrid material can be used. If higher light resistance is required, an inorganic material can be used as a binder.

Support member 104 is a member on which wavelength converter 105 is disposed. Support member 104 may be made of a material having a high thermal conductivity. Accordingly, support member 104 functions as a heat sink which dissipates the heat generated by wavelength converter 105. Support member 104 is made of, for example, a metal material, a ceramic material, or a semiconductor material. More specifically, support member 104 is made of a material including at least one of, for example, Cu, Al alloy, Si, AlN, Al₂O₃, GaN, SiC or diamond. Note that an optical film which reflects light having a wavelength converted by wavelength converter 105 may be disposed on the upper face of support member 104 (that is, between support member 104 and wavelength converter 105).

Light attenuator 106 is a member which reduces the amount of light emitted from second wavelength conversion region 112. With this configuration, light attenuator 106 can reduce the amount of outgoing light, and thus, it is possible to realize second wavelength conversion region 112 having a wavelength conversion efficiency lower than the wavelength conversion efficiency of first wavelength conversion region 111.

In the present embodiment, light attenuator 106 has an opening at a position corresponding to first wavelength conversion region 111. More specifically, light attenuator 106 is a film-shaped member having opening 106a in the middle, and is disposed on wavelength converter 105. In other words, in the present embodiment, wavelength converter 105 is exposed through opening 106a in the middle portion of light attenuator 106. As illustrated in FIG. 3A, the region of wavelength conversion element 103 corresponding to opening 106a of light attenuator 106 corresponds to first wavelength conversion region 111. In other words, first wavelength conversion region 111 is the region where wavelength converter 105 is exposed. In contrast, second wavelength conversion region 112 corresponds to the region where light attenuator 106 is disposed on wavelength converter 105. In the present embodiment, the shape of first wavelength conversion region 111 in a top view, that is, the shape of opening 106a of light attenuator 106 is circular, but it is not limited to being circular. The shape of first wavelength conversion region 111 in a top view may be, for example, rectangular. With the above configuration, it is possible to reduce the case where main light 122 enters light attenuator 106. Accordingly, light attenuator 106 can reduce the reduction of the wavelength conversion efficiency in first wavelength conversion region 111.

Moreover, the diameter of opening 106a is greater than or equal to the spot diameter of main light 122 on the surface of wavelength converter 105 where main light 122 enters. In this configuration, it is possible to reduce entrance of the high-intensity portion of main light 122 to light attenuator 106 by causing main light 122 to enter the center of the opening of light attenuator 106. Accordingly, light attenuator 106 can reduce the reduction of the wavelength conversion efficiency in first wavelength conversion region 111.

In the present embodiment, light attenuator 106 absorbs a portion of at least one of excitation light 121 or light having a wavelength converted by wavelength converter 105, and converts most of the absorbed light into heat. Accordingly, since light attenuator 106 absorbs the excitation light or the wavelength-converted light, it is possible to reduce the wavelength conversion efficiency in second wavelength conversion region 112. In the present embodiment, light attenuator 106 includes a material having a low reflectance relative to the wavelength of excitation light 121. For example, as light attenuator 106, a metal film of Au, Cu or the like, having a low reflectance for light of the wavelength of the excitation light, that is, for example, a reflectance of 60% or less for light having a wavelength of 500 nm or less, polysilicon having a low reflectance for visible light and having a high adhesion when a dielectric multilayer film is disposed above light attenuator 106, or metal silicide, such as SiW or SiTi, which is more stable in a high temperature range than a metal film can be used. Moreover, use of a stacked film including a combination of TiO₂, SiO₂ and the like on the surface of light attenuator 106 can further reduce reflectance by the interference effect. Moreover, light attenuator 106 may have high attenuating effects relative to, in particular, the wavelength of excitation light 121 by stacking a plurality of layers obtained by selecting, as a light absorbing material, at least one material from among Ti, Cr, Ni, Co, Mo, Si, Ge and the like, and selecting, as an anti-reflection material, at least one dielectric material from among SiO₂, Al₂O₃, TiO₂, Ra₂O₅, ZrO₂, Y₂O₃, Nb₂O₅ and the like.

### 1-2. Operation

Next, an operation of light source device 100 will be described with reference to the drawings.

As illustrated in FIG. 1, excitation light 121 emitted from optical waveguide 101a of semiconductor light-emitting element 101 becomes main light 122 which is light converged by converging optical system 102, and enters first wavelength conversion region 111 of wavelength conversion element 103.

Main light 122 entering first wavelength conversion region 111 is scattered or absorbed by wavelength converter 105, becomes outgoing light 124 including scattered light and fluorescence, and is emitted from light source device 100. Then, outgoing light 124 is projected as projection light 125 by light projecting member 120 such as an aspherical convex lens.

In contrast, light other than excitation light 121 is also emitted semiconductor light-emitting element 101. Hereinafter, the generation process of light other than excitation light 121 will be described with reference to FIG. 2B.

The electrical power provided from outside semiconductor light-emitting element 101 is partially converted into light by light-emitting layer 101d.

The most part of light generated at given light-emitting point 101g of light emitting layer 101d is amplified by light emitting layer 101d, and is emitted from light emitting surface 101f as excitation light 121 which is stimulated emission light.

In contrast, a portion of the light generated at light emitting point 101g propagates through light waveguide 101a while remaining as spontaneous emission light, and is emitted as second excitation light 121a from light emitting surface 101f.

Moreover, as described above, when GaN is used as substrate 101b, and AlGaN is used as second clad 101e, the refractive index of substrate 101b is greater than the refractive index of second clad 101e. In this case, it may be that a portion of the stimulated emission light propagates through substrate 101b, and is emitted from the substrate 101b part of light emitting surface 101f as third excitation light 121b having a broad distribution as indicated in, for example, the light intensity distribution in the right part of FIG. 2B.

Here, the emitting point of third excitation light 121b from light emitting surface 101f is not on the optical axis of excitation light 121. Therefore, even if third excitation light 121b is converted into third auxiliary light 122b which is light converged by converging optical system 102, converted third auxiliary light 122b does not enter first wavelength conversion region 111. In other words, third auxiliary light 122b entering wavelength conversion element 103 is emitted to the surrounding region of first wavelength conversion region 111 to which main light 122 is emitted, that is, second wavelength conversion region 112. Here, in the present embodiment, light attenuator 106 is disposed in second wavelength conversion region 112.

Therefore, a portion of third auxiliary light 122b is absorbed by light attenuator 106, and another portion of third auxiliary light 122b passes through light attenuator 106, and enters wavelength converter 105.

Third auxiliary light 122b reaching wavelength converter 105 becomes third outgoing light 123b including the diffused light and fluorescence. A portion of third outgoing light 123b is absorbed by light attenuator 106 and is emitted toward light projecting member 120. Third outgoing light 123b is then projected by light projecting member 120. However, since third outgoing light 123b has been attenuated by light attenuator 106, the influence of third outgoing light 123b on the projection image is small.

In contrast, it may be that a portion of excitation light 121 emitted from semiconductor light-emitting element 101 becomes auxiliary light other than main light 122 due to the surface condition of converging optical system 102 or the like, and is emitted from converging optical system 102. The generation of such auxiliary light will be described with reference to the drawings.

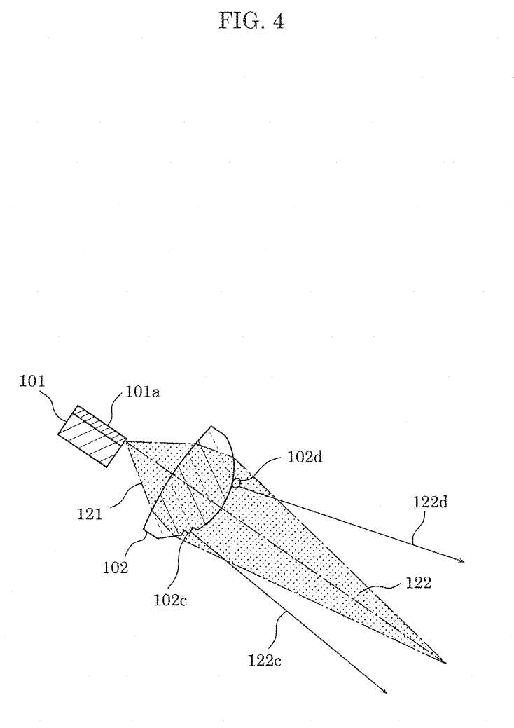

FIG. 4 is a cross-sectional view of an example of an operation of converging optical system 102 according to the present embodiment on excitation light 121 when an aspherical convex lens is used as converging optical system 102.

There may be cases where minute irregularities 102c are formed on the surface of converging optical system 102 by an impact or the like made during the manufacture or the operation, and where particles 102d of dust, dirt or the like adhere to the surface of converging optical system 102.

In these cases, excitation light 121 is diffracted by minute irregularities 102c and particles 102d. The diffraction can generate fourth auxiliary light 122c and fifth auxiliary light 122d. Such auxiliary light travel in a direction different from the converging direction of main light 122 and is emitted to the surrounding region of first wavelength conversion region 111.

For example, fourth outgoing light 123c generated by fourth auxiliary light 122c is also projected by light projecting member 120 in a similar manner to third outgoing light 123b.

However, since fourth outgoing light 123c has also been attenuated by attenuator 106 in a similar manner to third outgoing light 123b, the influence of fourth outgoing light 123c on the projection image is small.

In the above description, when main light 122 enters wavelength conversion element 103 obliquely as in the present embodiment, the above auxiliary light is emitted to wavelength conversion element 103 at a position farther from main light 122 than the case where main light 122 enters wavelength conversion element 103 vertically. Therefore, auxiliary light is more separated from main light, which increases the influence of the auxiliary light on the projection image. However, in the present embodiment, second wavelength conversion region 112 having a lower wavelength conversion efficiency is disposed in wavelength conversion element 103, in the surrounding region of the region to which main light 122 is emitted. Therefore, it is possible to reduce the influence of the auxiliary light on the projection image. As described above, according to light source device 100 in the present embodiment, among the excitation light coming from converging optical system 102 and entering wavelength conversion element 103, the excitation light excluding light 122 enters second wavelength conversion region 112 having a lower wavelength conversion efficiency. Accordingly, it is possible to reduce the outgoing light (stray light such as fourth outgoing light 123c) generated by the excitation light excluding main light 122 and emitted from light source device 100.

### 1-3. Projection Image

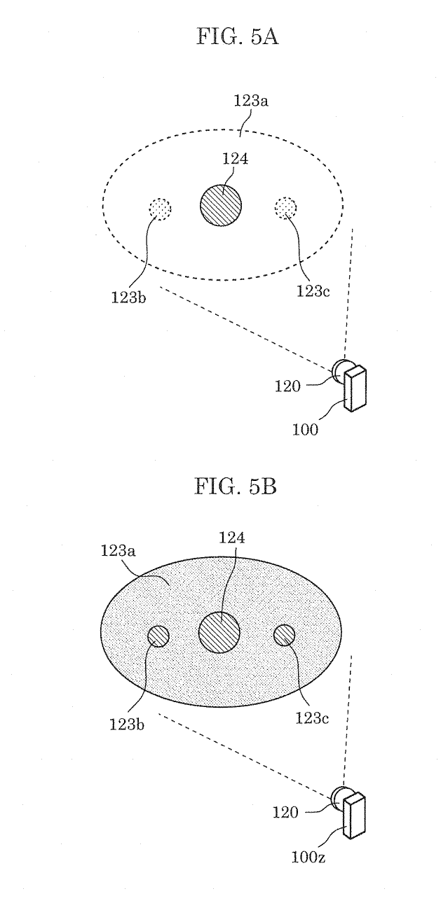

The effect of light source device 100 having the configuration described above on a projection image will be described with reference to FIG. 5A and FIG. 5B.

FIG. 5A schematically illustrates a projection image obtained when light source device 100 according to the present embodiment operates in combination with light projecting member 120.

FIG. 5B schematically illustrates a projection image obtained when light source device 100z according to a comparative example operates in combination with light projecting member 120.

Light source device 100z according to the comparative example is different from light source device 100 in that no light attenuator is included in a wavelength conversion element, that is, first wavelength conversion region 111 and second wavelength conversion region 112 are substantially the same in wavelength conversion efficiency. Light source device 100z is the same as light source device 100 in the other aspects.

As illustrated in FIG. 5B, in the projection image of light source device 100z according to the comparative example, second outgoing light 123a generated by second excitation light 121a is projected in the surrounding region of the projection image formed by outgoing light 124 emitted from first wavelength conversion region 111, so as to surround outgoing light 124. The illuminance of second outgoing light 123a is lower than the illuminance of outgoing light 124, but can be visually recognized. Moreover, the projection images formed by third outgoing light 123b and fourth outgoing light 123c are also projected around outgoing light 124 while generating strong illuminance unevenness.

In contrast, in light source device 100 according to the present embodiment, as illustrated in FIG. 5A, since the illuminance of second outgoing light 123a, third outgoing light 123b and fourth outgoing light 123c is reduced by light attenuator 106, a projection image can be obtained which has a large contrast between outgoing light 124 and the surrounding region.

Thus, for example, when light source device 100 according to the present embodiment is used for a vehicle headlamp, it is possible to easily control the illuminance distribution, such as increasing the illuminance onto the distant road surface and reducing the illuminance onto the surrounding region such as a sidewalk.

### 1-4. Specific Configuration Example

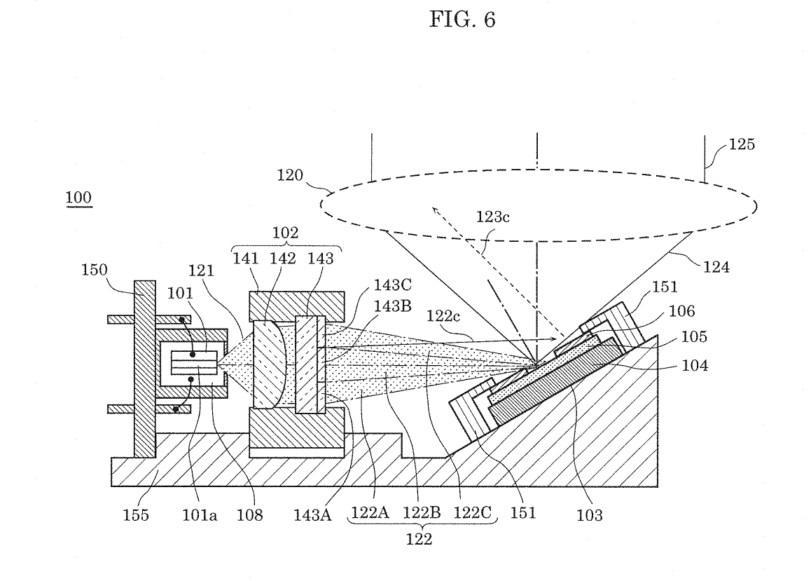

Hereinafter, a more specific configuration of light source device 100 will be described with reference to FIG. 6.

FIG. 6 is a cross-sectional view of a specific configuration of light device 100 according to the present embodiment.

As illustrated in FIG. 6, in light source device 100, semiconductor light-emitting element 101, converging optical system 102, and wavelength conversion element 103 are directly or indirectly fixed to support member 155 made of, for example, an aluminum alloy.

Semiconductor light-emitting element 101 is mounted on package 150 via support member 108 which is, for example, a silicon carbide substrate.

Converging optical system 102 includes, in holder 141 which is, for example, a metal barrel, lens 142 made of, for example, an aspheric convex lens, and optical element 143 including a plurality of optical regions 143A, 143B, and 143C such as a microlens array. Here, optical element 143 has a function of forming a light intensity distribution of excitation light 121 emitted from semiconductor light-emitting element 101. The interface of the plurality of optical regions 143A, 143B and 143C is optically discontinuous.

Wavelength conversion element 103 has the same configuration as the configuration illustrated in FIG. 3A, is fixed to support member 155 by solder or the like, and has an upper surface covered with light shielding cover 151 having an opening.

Here, it may be that the fixation is made so that the peripheral portion of second wavelength conversion region 112 of wavelength conversion element 103 is covered with light shielding cover 151. Light shielding cover 151 is made by, for example, molding an aluminum alloy subjected to alumite treatment for coloring the surface to black.

Here, it is possible to quickly exhaust the heat generated from the phosphor, by increasing the thermal conductivity of support member 104 and support member 155.

The incident angle of main light 122 relative to the surface of wavelength conversion element 103 from which fluorescence is emitted may be set such that the use efficiency of the fluorescence emitted from wavelength conversion element 103 is high. For example, relative to the vertical line drawn on the upper surface of wavelength converter 105, the incident angle may be in the range from 40° to 80°. Moreover, in order to reduce the surface reflection, the incident polarization direction of main light 122 may be P-polarization.

In light source device 100 having the above configuration, excitation light 121 emitted from semiconductor light-emitting element 101 is converged by lens 142 and optical element 143, becomes main light 122, and enters wavelength conversion element 103. Here, main light 122 includes main light 122A, 122B and 122C converted by optical regions 143A, 143B and 143C of optical element 143, and is converged on first wavelength conversion region 111 of wavelength conversion element 103. Here, the spot diameter of main light 122 at firs wavelength conversion region 111 is defined, for example, by the diameter at which the intensity is 1/e² with respect to the peak intensity. In the present embodiment, the spot diameter is in a range from 0.1 mm to 1 mm. Note that, in the present disclosure, the spot diameter is similarly defined with respect to light having a light intensity distribution other than a Gaussian distribution.

Main light 122 converged on first wavelength conversion region 111 is converted by wavelength converter 105 into light having different chromaticity coordinates such as white light having a correlated color temperature of 5500 K, for example. The converted light is then emitted as outgoing light 124 from the surface of wavelength converter 105 on the same side as the surface of wavelength converter 105 where main light 122 enters.

Outgoing light 124 emitted from light source device 100 enters light projecting member 120 such as an aspherical convex lens, and is emitted as projection light 125.

Here, excitation light 121 entering optical element 143 is diffracted by the optically discontinuous interface of optical element 143, thereby generating fourth auxiliary light 122c which is diffracted light.

Fourth auxiliary light 122c enters second wavelength conversion region 112 which is the surrounding region of first wavelength conversion region 111. Fourth auxiliary light 122c entering second wavelength conversion region 112 becomes fourth outgoing light 123c, and is projected by light projecting member 120. However, as described above, the conversion is performed by light attenuator 106 with a light conversion efficiency lower than the light conversion efficiency in first wavelength conversion region 111. Hence, it is possible to reduce the influence on the projection image.

### 1-5. Advantageous Effects

Now, the advantageous effects of light source device 100 according to the present embodiment will be described with reference to the drawings.

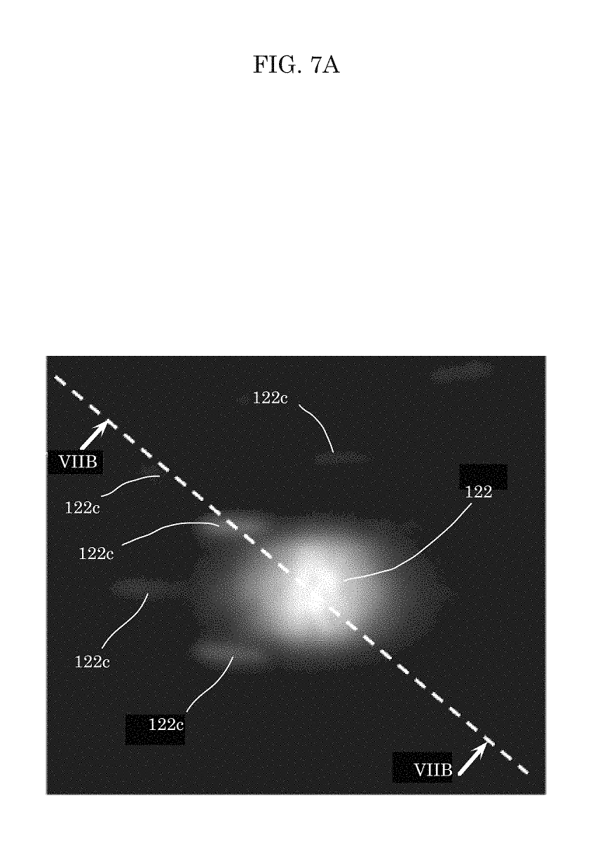

FIG. 7A illustrates a luminance distribution, measured using a wavelength conversion element which does not include a light attenuator in an optical system equivalent to light source device 100 according to the present embodiment illustrated in FIG. 6, of outgoing light emitted by emitting main light and auxiliary light to the surface corresponding to the surface of wavelength conversion element 103. In other words, a light source device is used which is different from light source device 100 in that the wavelength conversion efficiencies are approximately the same in first wavelength conversion region 111 and second wavelength conversion region 112, and which is the same as light source device 100 in the other aspects. As optical element 143, an optical element was used which had a surface on which a plurality of lenses are formed. In other words, optical element 143 was used which included lenses in optical regions 143A, 143B, and 143C respectively and which had discontinuous boundaries on the surface. Accordingly, the main light and auxiliary light enter the surface of wavelength conversion element 103 illustrated in FIG. 7A.

Here, as illustrated in the two-dimensional luminance distribution of FIG. 7A, in addition to the main peak made by outgoing light generated by main light 122, a plurality of side peaks made by outgoing light generated by fourth auxiliary light 122c can be observed from the surface of wavelength conversion element 103. As illustrated in FIG. 5B, these side peaks are observed as side peaks of the projection image.

The effect of use of light source device 100 according to the present embodiment on such side peaks will be described.

Hereinafter, the results of comparison of the luminance distribution in the region around main light 122 will be described with reference to FIG. 7B.

FIG. 7B illustrates graphs indicating the luminance distributions along line VIIB-VIIB of the luminance distribution illustrated in FIG. 7A, and comparing the luminance distributions in different wavelength conversion elements and different converging optical systems.

Luminance distribution (a) of FIG. 7B is a graph indicating the luminance distribution in the diagonal direction (VIIB-VIIB) including main light 122 of the luminance distribution illustrated in FIG. 7A. Luminance distribution 122G indicates a Gaussian distribution in which the spot width (the width at which the light intensity is 1/e² of the peak intensity) is 0.5 mm. In contrast, the luminance distribution of main light 122 is formed by optical element 143 such that the luminance near the luminance peak is flat at approximately 550 cd/mm² with the same spot width. However, the side peaks are observed near the positions −0.33 mm and −0.62 mm. Here, the luminance ratio of the main peak of main light 122 to the side peak of fourth auxiliary light 122c near the position of −0.33 mm is 12:1, which means only a low contrast is obtained.

In contrast, luminance distribution (b) of FIG. 7B is a graph indicating the result of calculation of the luminance distribution in the case where the configuration in the present embodiment is used.

In the present embodiment, light attenuator 106 is disposed in the region surrounding the region with a diameter of 0.55 mm or greater from the center of the emission region of main light 122. This region where light attenuator 106 is disposed serves as second wavelength conversion region 112. The region with a diameter of 0.55 mm or less from the center serves as first wavelength conversion region 111. Accordingly, first wavelength conversion region 111 is larger than the spot diameter of main light 122.

Moreover, in luminance distribution (b) of FIG. 7B, light attenuator 106 is designed so that light attenuator 106 absorbs excitation light and outgoing light, and the luminance of outgoing light is 1/10 as compared with the case where no light attenuator 106 is disposed. As a result, the region to which fourth auxiliary light 122c is emitted serves as second wavelength conversion region 112. Light attenuator 106 disposed in this region can reduce stray light as illustrated in luminance distribution (b) of FIG. 7B. Here, the luminance ratio of the main peak of main light 122 to the side peak of fourth auxiliary light 122c is 120:1. Accordingly, it is possible to realize light source device 100 in which the contrast between the emission region of the main light and the other emission regions are sufficiently large.

In contrast, when light source device 100 according to the present embodiment is used as a light source for a vehicle headlamp, for example, a strong vibration or impact is applied to light source device 100.

When an impact is applied to light source device 100 as described above, the position of converging optical system 102 may be displaced. Such a positional displacement of the converging optical system will be described with reference to the drawings.

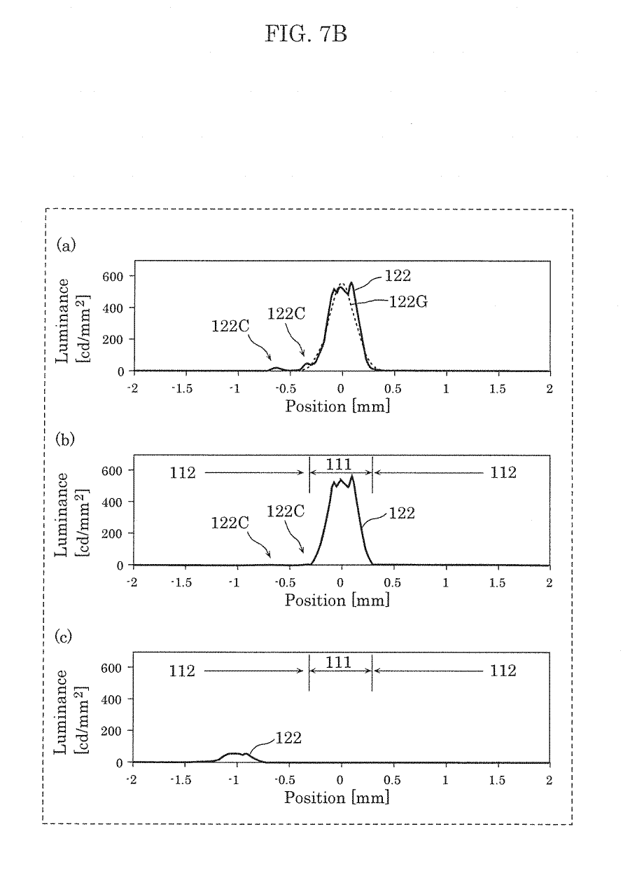

FIG. 8 is a cross-sectional view of an example of the positional displacement of converging optical system 102 in light source device 100 according to the present embodiment.

As illustrated in FIG. 8, the position of converging optical system 102 is displaced in the direction indicated by arrow A1 due to an application of a force to converging optical system 102 in the direction indicated by arrow A1. In this case, main light 122 is emitted to second wavelength conversion region 112. Here, although second wavelength conversion region 112 has a wavelength conversion efficiency lower than the wavelength conversion efficiency in first wavelength conversion region 111, second wavelength conversion region 112 can emit wavelength-converted light (that is fluorescence). For example, as illustrated in luminance distribution (c) of FIG. 7B, even if main light 122 is emitted to the position of −1.0 mm which is in second wavelength conversion region 112, wavelength-converted outgoing light 124 having a peak luminance at approximately 50 cd/mm² can be emitted. Although this peak luminance is less than the luminance of 550 cd/min² of the light emitted from first wavelength conversion region 111, light having a luminance greater than or equal to the luminance of a halogen lamp used for the vehicle headlamp (for example, luminance of 20 cd/mm²) can be emitted from light projecting member 120.

Accordingly, when light source device 100 according to the present embodiment is used for a vehicle headlamp, for example, even if a problem of the positional displacement of converging optical system 102 as illustrated in FIG. 8 occurs, outgoing light 124 is emitted from light source device 100. Accordingly, the visibility at the front of the vehicle can be ensured.

### Variation 1 of Embodiment 1

### 1A-1. Configuration

Hereinafter, wavelength conversion element 103a according to Variation 1 of Embodiment 1 will be described with reference to the drawings.

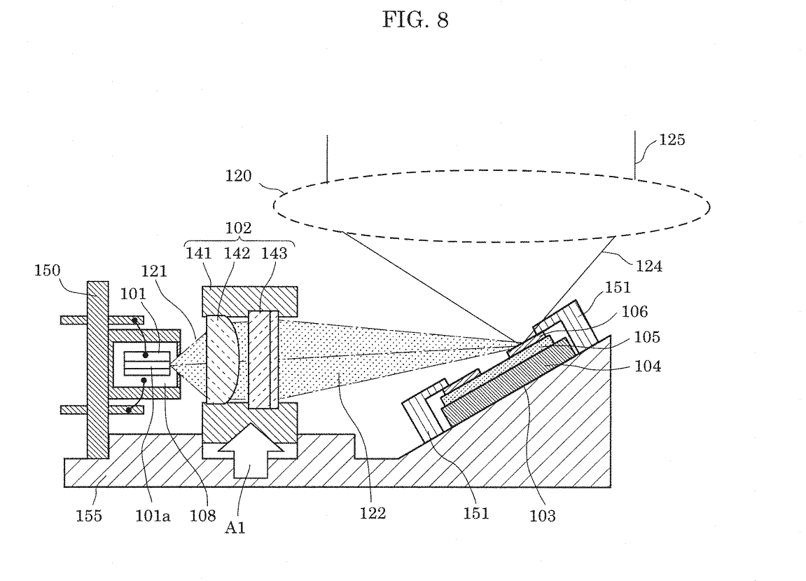

FIG. 9A is a schematic cross-sectional view of a schematic configuration of wavelength conversion element 103a according to the present variation.

FIG. 9B is a schematic top view of a schematic configuration of wavelength conversion element 103a according to the present variation. FIG. 9A illustrates a cross-section taken along IXA-IXA in FIG. 9B.

In a similar manner to wavelength conversion element 103 according to Embodiment 1, wavelength conversion element 103a includes first wavelength conversion region 111 in the central portion, and second wavelength conversion region 112 in the surrounding region of first wavelength conversion region 111. Second wavelength conversion region 112 has, relative to excitation light, a wavelength conversion efficiency lower than first wavelength conversion region 111.

In wavelength conversion element 103a according to the present variation, main light 122 enters wavelength converter 105 obliquely relative to the surface of wavelength converter 105. Wavelength conversion element 103a includes, in second wavelength conversion region 112, projection 160 to which light reflected by the surface of wavelength converter 105 is emitted while maintaining the directivity of the main light. In the present variation, projection 160 is disposed above wavelength converter 105 or light attenuator 106, at a position adjacent to opening 106a in first wavelength conversion region 111. Here, projection 160 is disposed on wavelength conversion element 103a, at an opposite side to the side from which main light 122 enters.

Here, the minimum height of projection 160 with which projection 160 can provide advantageous effects will be described. Minimum height h can be calculated from distance d from the central position of the spot to which main light is emitted to the side wall of projection 160 and angle θ at which main light 122 enters wavelength converter 105 relative to the vertical line drawn on the upper surface of wavelength converter 105. The equation is as follows.

h=tan (90−θ)×2d (Equation 1)

Here, for example, distance d is at least 0.05 mm, and θ is in a range from 40° to 80°.

For example, when minimum height h of projection 160 is 0.18 mm when d is 0.25 and θ is 70°.

Moreover, the width of projection 160 (that is, the vertical size of projection 160 in FIG. 9B) may be greater than the maximum width of first wavelength conversion region 111. Accordingly; among the reflected light of main light 122, most part of the reflected light reflected while maintaining the directivity of main light 122 can be emitted to projection 160.

### 1A-2. Manufacturing Method

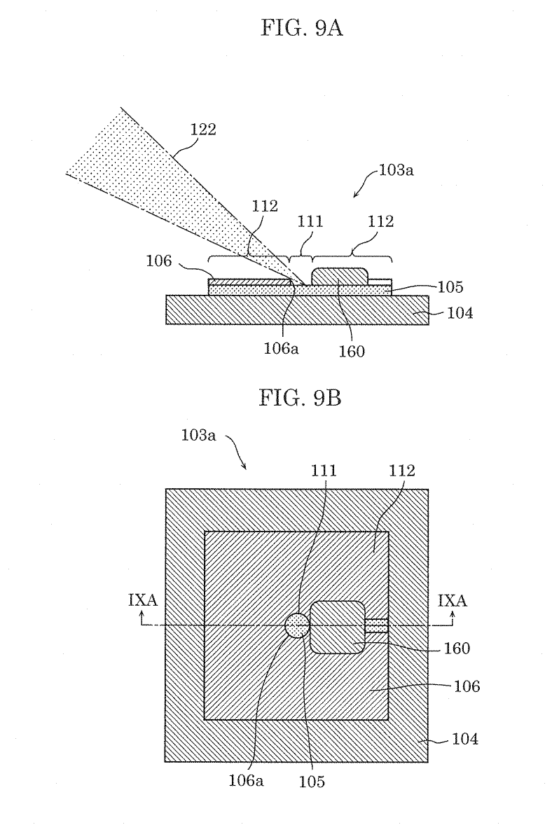

A method for manufacturing wavelength conversion element 103a according to the present variation of Embodiment 1 will be described with reference to FIG. 10.

FIG. 10 schematically illustrates each step of the method for manufacturing wavelength conversion element 103a according to the present variation.

As illustrated in cross-sectional view (a) of FIG. 10, optical film 104a made of Nb₂O₅/SiO₂ is formed on support member 104 made of, for example, a Si substrate, by an electron beam evaporator. Note that optical film 104a may be formed by forming a reflection enhancing film made of a dielectric material on a metal film of Ag, Ag alloy (for example, silver-palladium copper (APC) alloy), Al or the like, Subsequently, phosphor paste 170 is prepared by mixing phosphor particles 171 made of YAG:Ce and binder 172 made of, for example, polysilsesquioxane as an organic-inorganic hybrid material, and is applied into opening 175a on optical film 104a, Accordingly, as illustrated in cross-sectional view (b) of FIG. 10, phosphor paste 170 is filled into opening mask 175.

Next, as illustrated in cross-sectional view (c) of FIG. 10, phosphor paste 170 protruding above opening mask 175 is removed using opening mask 175.

Next, as illustrated in cross-sectional view (d) of FIG. 10, opening mask 175 is removed to cure the binder at approximately 200° C.

Next, as illustrated in cross-sectional view (e) of FIG. 10, light attenuator 106 is formed using opening mask 176. Here, since opening mask 176 covers the region above first wavelength conversion region, an opening mask having a key-shaped pattern with a support portion (not illustrated) is used. Then, in order to form light attenuator 106, for example, at least one material selected from among Au, Cu, Si, Ti, W, and Mo is stacked from above opening mask 176 using an electron beam evaporation, a sputtering device or the like. Here, on the stacked materials, stacked films including a combination of Nb₂O₅, Ta₂O₅, SiO₂, Al₂O₃ and the like may be further formed.

Subsequently, as illustrated in top view (f) of FIG. 10, light attenuator 106 through which wavelength converter 105 is exposed can be obtained by removing opening mask 176.

Next, as illustrated in cross-sectional view (g) of FIG. 10, using opening mask 177, fine particle paste 180 including fine particles in a binder is applied to a position adjacent to the central portion of wavelength converter 105 to which main light 122 is emitted.

Subsequently, as illustrated in cross-sectional view (h) of FIG. 10, it is possible to form projection 160 by curing the binder.

Here, as fine particles, for example, TiO₂ particles, or Al₂O₃ particles having an average particle diameter ranging from 0.5 μm to 10 μm may be used. More preferably, as the fine particle size, particles having average particle diameter D50 of, for example, 2 μm are used.

In the above described manner, it is possible to manufacture wavelength conversion element 103a including projection 160.

### 1A-3. Advantageous Effects

The advantageous effects of the present variation will be described with reference to the drawings.

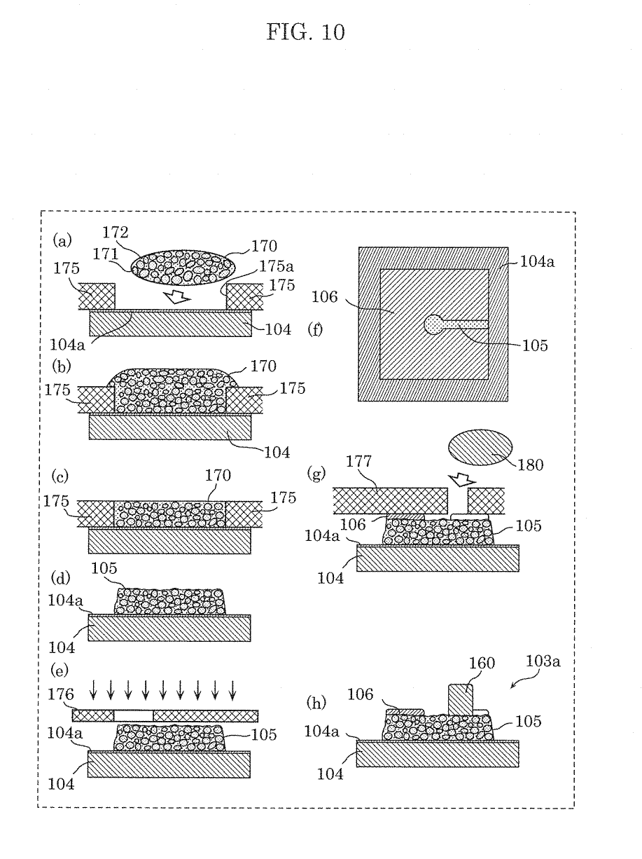

FIG. 11A schematically illustrates an optical path of reflected light 131 of main light 122 on wavelength conversion element 103a according to the present variation.

FIG. 11B schematically illustrates an optical path of reflected light 131 of main light 122 on wavelength conversion element 103 according to Embodiment 1.

As illustrated in FIG. 11A and FIG. 11B, in wavelength conversion element 103a according to the present variation and wavelength conversion element 103 according to Embodiment 1, when main light 122 enters wavelength converter 105, reflected light 131 is generated which has a directivity approximately the same as the directivity of main light 122.

Therefore, as illustrated in FIG. 11B, when wavelength conversion element 103 does not include projection 160, reflected light 131 is emitted from light source device 100 as stray light having a high directivity. In contrast, wavelength conversion element 103a according to the present variation includes projection 160. Hence, instead of reflected light 131, scattered light 132 having a low directivity can be emitted by scattering reflected light 131. In this way, in the present variation, it is possible to reduce the case where reflected light 131 having a high directivity is emitted from the light source device.

Moreover, in the present variation, in second wavelength conversion region 112, the portion of wavelength converter 105 not covered with light attenuator 106 can be covered with projection 160 (see FIG. 9B). For example, in the case where light attenuator 106 is disposed, as illustrated in top view (f) of FIG. 10, it may be that an opening has to be formed at the position other than the central portion, too. However, in the present variation, in second wavelength conversion region 112, the portion of wavelength converter 105 not covered with light attenuator 106 can be covered with projection 160. Accordingly, it is possible to reduce formation of a region having a high wavelength conversion efficiency in second wavelength conversion region 112, thereby reducing the outgoing light generated by the excitation light excluding main light 122 and emitted from the light source device.

### Embodiment 2

Next, a wavelength conversion element according to Embodiment 2 and a light source device including the wavelength conversion element will be described, The wavelength conversion element according to the present embodiment is different from wavelength conversion element 103 according to Embodiment 1 in that no light attenuator is included, and in that the wavelength conversion efficiencies of the first wavelength conversion region and the second wavelength conversion region are adjusted by the thickness of the wavelength converter. Hereinafter, the light source device according to the present embodiment will be described with reference to the drawings.

### 2-1. Configuration

A configuration of the wavelength conversion element according to the present embodiment will be described with reference to the drawings.

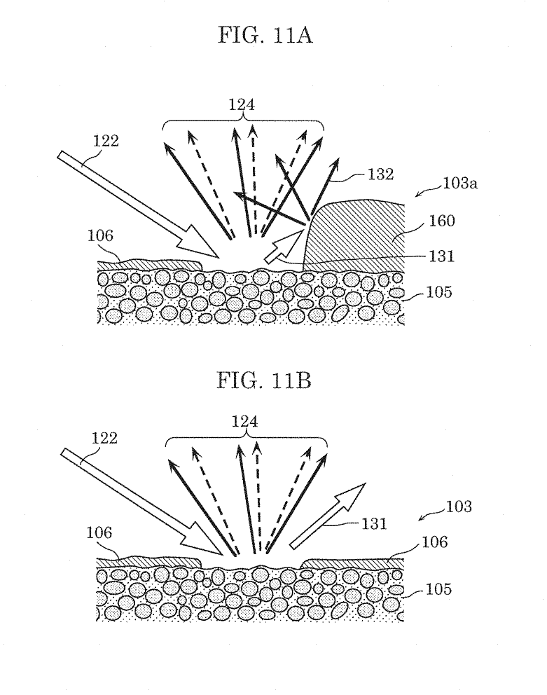

FIG. 12A is a schematic cross-sectional view of a schematic configuration of wavelength conversion element 203 according to the present embodiment.

FIG. 12B is a schematic top view of a schematic configuration of wavelength conversion element 203 according to the present embodiment. Note that FIG. 12A illustrates a cross-section taken along line XIIA-XIIA in FIG. 12B.

As illustrated in FIG. 12A and FIG. 12B, wavelength conversion element 203 includes support member 204 and wavelength converter 205 disposed on support member 204. Wavelength conversion element 203 includes first wavelength conversion region 211 in the central portion, and second wavelength conversion region 212 in the surrounding region of first wavelength conversion region 211. The thickness of wavelength converter 205 is less in second wavelength conversion region 212 than in first wavelength conversion region 211. In the present embodiment, the shape of first wavelength conversion region 211 in a top view is rectangular, but it is not limited to being rectangular. The shape may be, for example, circular.

### 2-2. Manufacturing Method

A method for manufacturing wavelength conversion element 203 according to the present embodiment will be described with reference to the drawings. In the manufacturing method, wavelength converter 205 includes a phosphor and a binder. As the phosphor, aluminate phosphor such as YAG:Ce³⁺ having an average particle diameter of at least 1 μm and at most 10 μm is used. As the binder, silsesquioxanes such as polysilsesquioxane is mainly used. Moreover, wavelength converter 205 may include a diffusion material which diffuses main light 122. As the diffusion material, fine particles of alumina or the like can be used which have an average particle diameter of at least 1 μm and at most 10 μm.

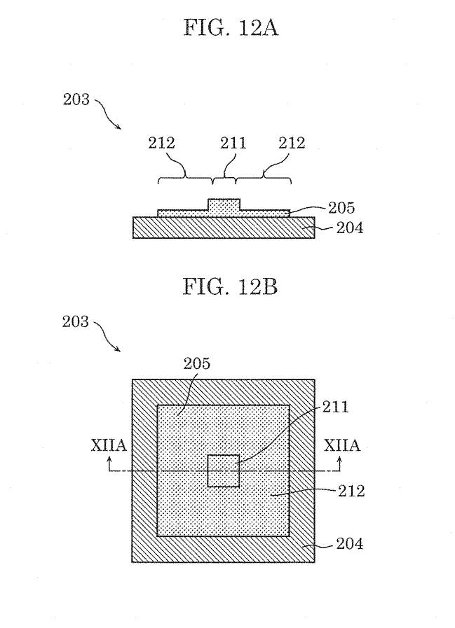

FIG. 13 schematically illustrates each step of the method for manufacturing wavelength conversion element 203 according to the present embodiment.

As illustrated in cross-sectional view (a) of FIG. 13, optical film 204a, wavelength conversion film 205M having a thickness of, for example, at least 10 μm and at most 200 μm, and mask 275 are formed on support member 204. Optical film 204a and wavelength conversion film 205M respectively have the same configuration as optical film 104a and wavelength converter 105 of wavelength conversion element 103a according to Variation 1 of Embodiment 1. After wavelength conversion film 205M is formed, mask 275 is formed in the central portion of wavelength conversion film 205M, using, for example, a metal mask or a resist mask.

Next, as illustrated in cross-sectional view (b) of 13, fluorine-based dry etching or wet etching using ammonium fluoride is performed to etch the binder made of silsesquioxanes. Then, the phosphor is removed together with the binder, and wavelength converter 205 is formed by thinning wavelength conversion film 205M excluding the central portion to have a thickness of, for example, at least 5 μm and at most 100 μm.

Next, as illustrated in cross-sectional view (c) of FIG. 13, wavelength conversion element 203 according to the present embodiment can be manufactured by removing mask 275.

### 2-3. Advantageous Effect

By configuring wavelength conversion element 203 as described above, the thickness of wavelength converter 205 (that is, film thickness) is less in second wavelength conversion region 212 than in first wavelength conversion region 211. Accordingly, since the amount of phosphor in second wavelength conversion region 212 is smaller, the wavelength conversion efficiency in second wavelength conversion region 212 is lower than the wavelength conversion efficiency in first wavelength conversion region 211. Therefore, it is possible to reduce the outgoing light (stray light) generated by the excitation light entering second wavelength conversion region 212.

Moreover, in the above description, a binder which allows etching is used as the material for forming wavelength converter 205. With this configuration, it is possible to form wavelength conversion element 203 easier.

The kind of the binder used here is not limited to the binder mentioned above as long as etching can be performed. For example, SiO₂, ZnO, ZrO₂, Al₂O₃, or BaO can be selected, Moreover, the thickness of wavelength converter 205 may be increased by adding, as the material for forming wavelength converter 205, fine particles of Al₂O₃, ZnO or the like having a high thermal conductivity to the phosphor to reduce the phosphor ratio while maintaining a high average thermal conductivity of wavelength converter 205. This increases the difference in thickness of the wavelength converter between the first wavelength conversion region and the second wavelength conversion region, thereby increasing the difference in conversion efficiency.

### 2-4. Specific Configuration Example

Hereinafter, a specific configuration of the light source device according to the present embodiment will be described with reference to the drawings.

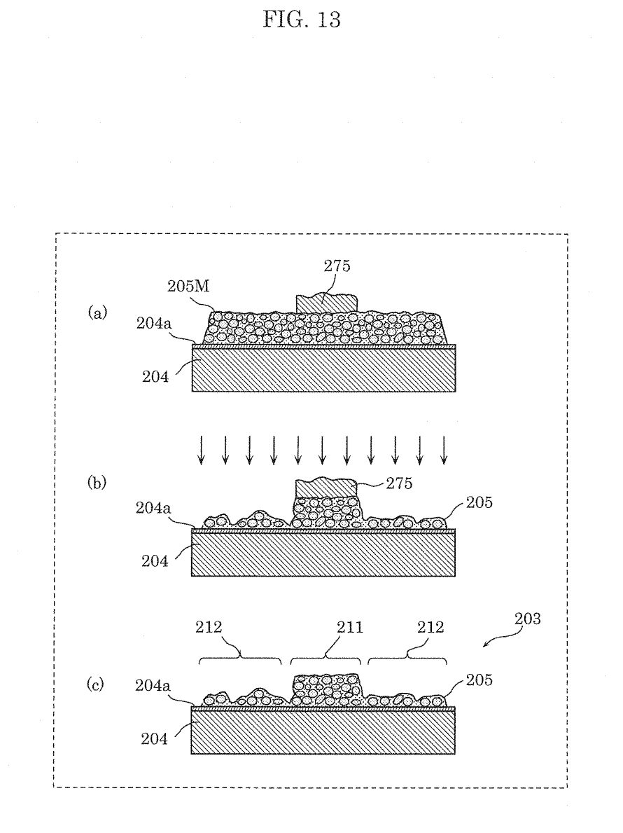

FIG. 14 is a cross-sectional view of a specific configuration of light source device 200 according to the present embodiment.

As illustrated in FIG. 14, light source device 200 includes semiconductor light-emitting element 101, converging optical system 102, wavelength conversion element 203, and light projecting member 220 which are arranged along the same optical axis. Semiconductor light-emitting element 101, converging optical system 102, wavelength conversion element 203, and light projecting member 220 are arranged in the mentioned order. As illustrated in FIG. 14, in light source device 200 according to the present embodiment, semiconductor light-emitting element 101 is disposed opposite to light projecting member 220 relative to wavelength conversion element 203. Excitation light 121 emitted from semiconductor light-emitting element 101 enters wavelength conversion element 203 from the support member 204 side.

Converging optical system 102 incudes: lens 242 which is, for example, an aspherical convex lens, and optical element 243 which includes a plurality of regions connected by an optically discontinuous interface. In the present embodiment, optical element 243 includes first optical surface 243a and second optical surface 243b. First optical surface 243a includes a plurality of microlenses connected by an optically discontinuous interface. Second optical surface 243b has an aspherical convex curved surface.

Hereinafter, a configuration of wavelength conversion element 203 will be described.

Wavelength conversion element 203 includes, as illustrated in FIG. 14, support member 204, optical film 204a, and wavelength converter 205.

Support member 204 is made of a light transmitting member, and is a member having a high thermal conductivity such as sapphire, AlN, Al₂O₃, GaN, SiC or diamond. It is possible to quickly exhaust the heat generated by wavelength converter 205 from support member 204 by increasing the thermal conductivity of support member 204. In other words, it is possible to enhance the heat dissipating properties of support member 204.

On the surface of support member 204, which is opposite to the surface contacting wavelength converter 205 (the surface on the lower side in FIG. 14), an anti-reflection film (not illustrated) is disposed in order to reduce the reflection caused due to the refractive index difference of excitation light 121.

Moreover, optical film 204a, such as a dichroic film which transmits light, having the wavelength of excitation light 121 and reflects light having the wavelength of the fluorescence emitted from wavelength converter 205 (wavelength-converted light) may be formed on the interface at which support member 204 and wavelength converter 205 contact to each other. Such optical film 204a can reflect fluorescence propagating from wavelength, converter 205 toward support member 204 and emit the reflected fluorescence from wavelength converter 205 toward light projecting member 220. Therefore, it is possible to effectively use the fluorescence generated by wavelength converter 205.

Wavelength converter 205 includes a phosphor material and a binder for holding the phosphor material. As the phosphor material and the binder, it is possible to use the same material as the material of wavelength converter 105.

Here, wavelength conversion element 203 includes first wavelength conversion region 211 in the central portion, and second wavelength conversion region 212 in the surrounding region of first wavelength conversion region 211. The thickness (film thickness) of wavelength converter 205 is less in second wavelength conversion region 212 than in first wavelength conversion region 211.

Moreover, the width of first wavelength conversion region 211 may be approximately the same as the spot diameter of main light 222. Here, it is possible to realize light source device 200 having high luminance by setting the width of first wavelength conversion region 211 to at least 0.1 mm and at most 1 mm.

Moreover, an antireflection structure for preventing reflection of excitation light 121 may be formed on the upper surface of wavelength converter 205.

The light intensity distribution of excitation light 121 emitted from semiconductor light-emitting element 101 in the above configuration is formed by lens 242 and optical element 243, and excitation light 121 becomes main light 222 which is converging light, and enters wavelength conversion element 203.

Main light 222 entering wavelength conversion element 203 passes through support member 204 and optical film 204a, and enters wavelength converter 205 in first wavelength conversion region 111. In other words, main light 222 enters wavelength converter 205 through the plurality of regions of optical element 243.

Here, the maximum spot width on first wavelength conversion region 211 (the width of 1/e² intensity) is at least 0.1 mm and at most 1 mm.

Main light 222 entering wavelength converter 205 is scattered or absorbed, and is emitted as outgoing light 224 from the opposite side (the upper surface in FIG. 14) to the side of wavelength converter 205 where main light 222 enters.

Outgoing light 224 is projected as projection light 225 by light projecting member 220 such as an aspherical convex lens.

A portion of excitation light 121 entering optical element 243 is diffracted by the optically discontinuous interface of optical element 243 and becomes fourth auxiliary light 222c, and is emitted to second wavelength conversion region 212.

As described above, in the present embodiment, fourth auxiliary light 222c is generated by converging optical system 102, and is emitted to wavelength conversion element 203. However, fourth auxiliary light 222c is emitted to second wavelength conversion region 212. In the present embodiment, since the wavelength conversion efficiency in second wavelength conversion region 212 is low, outgoing light (stray light) generated by fourth auxiliary light 222c can be reduced.

Moreover, in the present embodiment, main light 222 enters the surface of wavelength conversion element 203 on the side opposite to the side from which outgoing light 224 is emitted. Accordingly, the reflected light generated when main light 222 enters wavelength conversion element 203 propagates in the direction opposite to the direction of outgoing light 224. Accordingly, in the present embodiment, it is possible to further reduce the outgoing light (stray light) which is generated by reflected light generated when main light 222 enters wavelength conversion element 203 and which is emitted from light source device 200.

Moreover, as in the present embodiment, when the emitted position of main light 222 is on the back side of the position of wavelength conversion element 203 from which outgoing light 224 is emitted, it is generally difficult to adjust the emitted position of main light 222 on wavelength conversion element 203 to a predetermined position. However, in the present embodiment, wavelength conversion is performed not only in first wavelength conversion region 211 but also in second wavelength conversion region 212. Hence, even when main light 222 is emitted to second wavelength conversion region 212, outgoing light 224 is emitted. Therefore, the emitted position of main light 222 can be visually recognized, so that the emitted position can be easily adjusted to first wavelength conversion region 211.

### Variation 1 of Embodiment 2

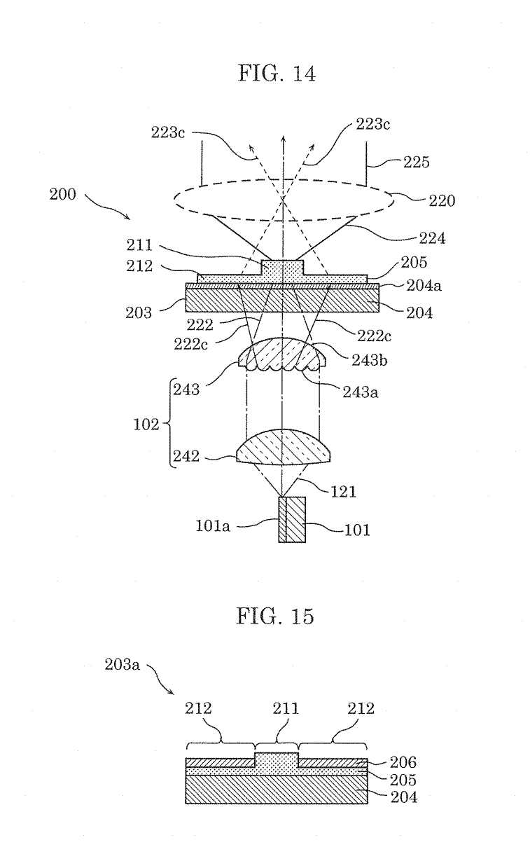

A wavelength conversion element according to Variation 1 of Embodiment 2 will be described. The wavelength conversion element according to the present variation is different from wavelength conversion element 203 according to Embodiment 2 in that a light attenuator is included, but is the same as wavelength conversion element 203 in the other aspects. Hereinafter, the wavelength conversion element according to the present variation will be described focusing on the differences from wavelength conversion element 203 according to Embodiment 2, with reference to FIG. 15.

FIG. 15 is a schematic cross-sectional view of a schematic configuration of wavelength conversion element 203a according to the present variation. In a similar manner to FIG. 12A, FIG. 15 illustrates a cross section which passes near the center of wavelength conversion element 203a and which is vertical to the main face of support member 204.

As illustrated in FIG. 15, wavelength conversion element 203a includes support member 204 and wavelength converter 205 that is disposed on support member 204. Wavelength conversion element 203a further includes light attenuator 206 in the upper part of second wavelength conversion region 212. In the present variation, the surface of light attenuator 206 on the side where excitation light enters (the upper side surface in FIG. 15) is lower than the surface of first wavelength conversion region 211 where light enters (the upper side surface in FIG. 15). In other words, wavelength converter 205 in first wavelength conversion region 211 protrudes beyond light attenuator 206. Moreover, light attenuator 206 may be in contact with the side surface of wavelength converter 205 in first wavelength conversion region 211 (the surface in first wavelength conversion region 211 extending in the vertical direction in FIG. 15).

With the above configuration, in a similar manner to wavelength conversion element 203 according to Embodiment 2, it is possible to reduce the case where the excitation light emitted from semiconductor light-emitting element 101 or converging optical system 102 and entering the region other than first wavelength conversion region 211 is projected as outgoing light (stray light). Moreover, when the position of converging optical system 102 is displaced due to an impact or the like made to light source device 200, main light 222 is emitted to second wavelength conversion region 212 which is in the surrounding region of first wavelength conversion region 211, and wavelength-converted light can be emitted by light projecting member 220. Therefore, even when light source device 200 has a problem such as positional displacement of converging optical system 102, it is possible to reduce the case where no light is emitted from light source device 200. Moreover, even if the outer edge of main light spreads to second wavelength conversion region 212, the wavelength of the main light is converted with a light emission efficiency lower than first wavelength conversion region 211. Hence, it is also possible to increase the light emission efficiency.

### Embodiment 3

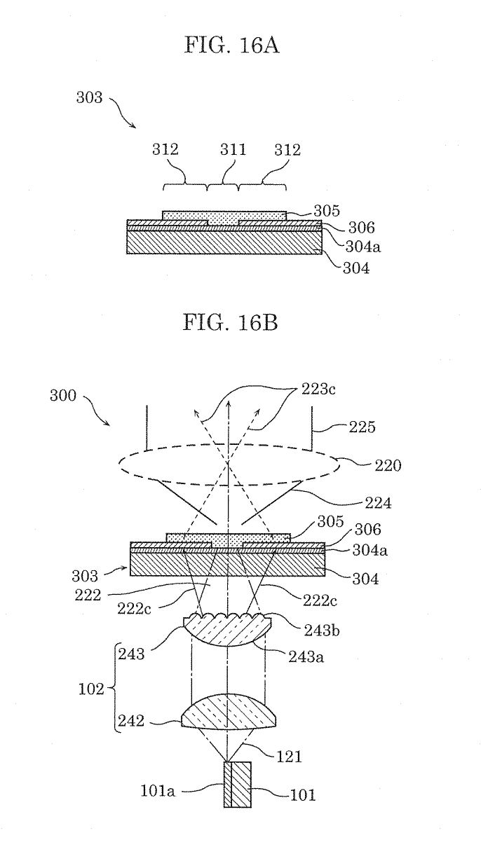

Next, a wavelength conversion element and a light source device according to Embodiment 3 will be described. The light source device according to the present embodiment is different from light source device 200 according to Embodiment 2 mainly in that the wavelength conversion element includes a light attenuator. Hereinafter, the light source device according to Embodiment 3 will be described focusing on the differences from light source device 200 according Embodiment 2, with reference to the drawings. FIG. 16A is a schematic cross-sectional view of a schematic configuration of wavelength conversion element 303 according to the present embodiment. In a similar manner to FIG. 12A and the like, FIG. 16A illustrates a cross section which passes near the center of wavelength conversion element 303 and which is vertical to the main face of support member 304.

As illustrated in FIG, 16A, wavelength conversion element 303 according to the present embodiment includes support member 304, optical film 304a, wavelength converter 305, and light attenuator 306. Support member 304 has the same configuration as support member 204 of wavelength conversion element 203 according to Embodiment 2.

Optical film 304a is a member which reflects fluorescence emitted from wavelength converter 305 (wavelength-converted light). In the present embodiment, optical film 304a is a dichroic film including a dielectric multilayer film formed on the surface of support member 304.

Light attenuator 306 is a member made of the same material as the material of light attenuator 106 according to Embodiment 1. In the present embodiment, light attenuator 306 is disposed between optical film 304a and wavelength converter 305. Light attenuator 306 has an opening in the middle. The shape of the opening of light attenuator 306 is not particularly limited, but may be appropriately determined depending on the application. The shape may be, for example, circular, rectangular, or square.

Wavelength converter 305 is a member including, for example, a Ce-activated garnet-based phosphor, and is disposed over the opening of light attenuator 306, and on light attenuator 306 (upper side in FIG. 16A).

In the present embodiment, first wavelength conversion region 311 is above the opening of light attenuator 306. Moreover, second wavelength conversion region 312 is the surrounding region of first wavelength conversion region 311 and where wavelength converter 305 is formed.

Subsequently, a configuration of light source device 300 according to the present embodiment will be described with reference to FIG. 16B.

FIG. 16B is a cross-sectional view of a specific configuration of light source device 300 according to the present embodiment.

In the present embodiment, as the material for forming support member 304, a material is used which is transparent to excitation light 121 and which has a high thermal conductivity. Specifically, a sapphire substrate is used as a material for forming support member 304.

Moreover, optical film 304a is a dichroic film which transmits light having a wavelength shorter than 490 nm and reflects light having a wavelength longer than 490 nm.

Excitation light 121 emitted from optical waveguide 101a of semiconductor light-emitting element 101 which is, for example, a nitride semiconductor laser element is converged by converging optical systems 102, and enters wavelength conversion element 303 from the supporting member 304 side (the lower side in FIG. 16B).

In the present embodiment, converging optical system 102 includes lens 242, and optical element 243. Optical element 243 includes first optical surface 243a and second optical surface 243b. First optical surface 243a has aspherical convex curved surface. Second optical surface 243b includes a plurality of microlenses connected by an optically discontinuous interface.

Here, main light 222 converged by converging optical system 102 enters wavelength converter 305 through the opening in the central portion of light attenuator 306.

Main light 222 entering wavelength converter 305 is converted by wavelength converter 305 into outgoing light 224 including the scattered excitation light and fluorescence, and is projected as projection light 225 by light projecting member 220.

In the above configuration, fourth auxiliary light 222c, which is diffracted light generated by second optical surface 243b of optical element 243, is emitted to second wavelength conversion region 312 which is in the surrounding region of first wavelength conversion region 311 of wavelength conversion element 303. Here, light attenuator 306 is disposed closer to the side where light enters closer to converging optical system 102) than wavelength converter 305 is.

In the present embodiment, in a similar manner to light source device 200 according to Embodiment 2, main light 222 enters wavelength conversion element 303 from the side opposite to the side from which outgoing light 224 is emitted. Accordingly, in the present embodiment, it is possible to further reduce the outgoing light stray light) which is generated by reflected light generated when main light 222 enters wavelength conversion element 303 and which is emitted from light source device 300.

Moreover, wavelength conversion element 303 according to the present embodiment includes light attenuator 306 in second wavelength conversion region 312. Accordingly, it is possible reduce light emitted from second wavelength conversion region 312 compared to wavelength conversion element 203 according to Embodiment 2.

Although it has been described above that converging optical system 102 includes lens 242 and optical element 243, but the configuration of converging optical system 102 is not limited to such a configuration. Converging optical system 102 may include three or more optical systems including a lens. Moreover, a converging optical system may include one optical element formed by integrating lens 242 and optical element 243 and having an aspherical curved surface having a greater curvature on one side and a plurality of microlenses on the other side. This leads to a light source device with a simpler configuration.

### Embodiment 4

Next, a wavelength conversion element according to Embodiment 4 will be described. The wavelength conversion element according to the present embodiment is different from wavelength conversion element 203 according to Embodiment 2 mainly in that a support member has a recess. Hereinafter, the wavelength conversion element according to the present embodiment will be described focusing on the differences from wavelength conversion element 203 according to Embodiment 2, with reference to the drawings.

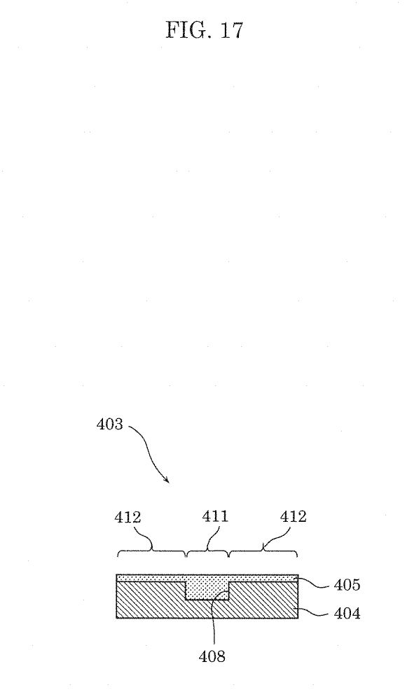

FIG. 17 is a schematic cross-sectional view of a schematic configuration of wavelength conversion element 403 according to the present embodiment in a similar manner to FIG. 12A and the like, FIG. 17 illustrates a cross section which passes near the center of wavelength conversion element 403 and which is vertical to the main face of support member 404.

As illustrated in FIG. 17, wavelength conversion element 403 according to the present embodiment includes support member 404 and wavelength converter 405.

In the present embodiment, support member 404 has recess 408.

Wavelength converter 405 is disposed in recess 408 and the surrounding region of recess 408. In other words, recess 408 of support member 404 and the surrounding region of recess 408 are covered with wavelength converter 405.

In the present embodiment, first wavelength conversion region 411 is wavelength converter 405 disposed on recess 408, and second wavelength conversion region 412 is wavelength converter 405 disposed in the region other than recess 408.

Therefore, the thickness of wavelength converter 405 in first wavelength conversion region 411 is greater than the thickness of wavelength converter 405 in second wavelength conversion region 412.

With this configuration, it is possible to set the wavelength conversion efficiency in second wavelength conversion region 412 relative to the light quantity of the excitation light to be lower than first wavelength conversion region 411.

The depth of recess 408 of support member 404 may be greater than or equal to the average particle diameter of the phosphors mixed in wavelength converter 405. Accordingly, the amount of phosphors per unit area in recess 408 can be set to be greater than the amount of phosphors per unit area in the surrounding region of recess 408.

The shape of recess 408 may be a tapered shape opened upward (upward in FIG. 17). Moreover, the region near the bottom of recess 408 may have a curvature.

Next, a detailed configuration and a manufacturing method of wavelength conversion element 403 according to the present embodiment will be described with reference to the drawings.

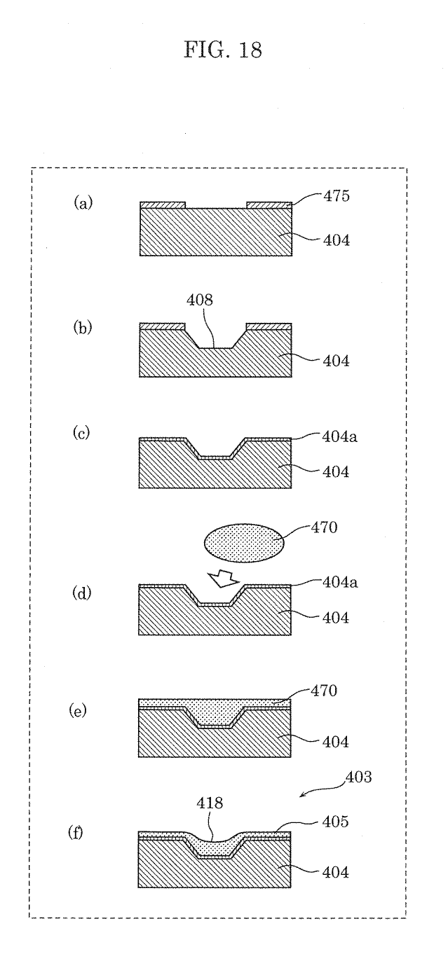

FIG. 18 illustrates each step of the method for manufacturing wavelength conversion element 403 according to the present embodiment.

First, as illustrated in cross-sectional view (a) of FIG. 18, support member 404 is prepared, and opening mask 475 is formed over the upper surface of support member 404. In the present embodiment, a Si substrate is used as support member 404. A SiO₂ film is formed on the surface of support member 404 by thermal oxidation, and opening mask 475 is formed by photolithography and wet etching using hydrofluoric acid.

Subsequently, as illustrated in the cross-sectional view (b) of FIG. 18, recess 408 is formed in support member 404 by performing etching such as anisotropic etching with a KOH solution.

Subsequently, as illustrated in cross-sectional view (c) of FIG, 18, opening mask 475 is removed and optical film 404a is formed by using, for example, an electron beam evaporation or sputtering. Optical film 404a is, for example, formed by at least one of a dielectric multilayer film or a metal film of Ag or the like.

Subsequently, as illustrated in cross-sectional view (d) of FIG. 18, phosphor paste 470 including a mixture of phosphor particles and a binder is applied from above. As the phosphor particles, for example, YAG yellow phosphors can be used. As the binder, for example, polysilsesquioxane can be used.

Subsequently, as illustrated in cross-sectional view (e) of FIG. 18, a film of phosphor paste 470 is formed on support member 404 using an opening mask having a predetermined thickness. Here, the thickness of phosphor paste 470 in first wavelength conversion region 411 corresponding to recess 408 is greater by the depth of recess 408 than other portions.

Subsequently, support member 404 coated with phosphor paste 470 is heated at a high temperature tank of 150° C. to 200° C. so that phosphor paste 470 is cured. In this way, wavelength converter 405 can be formed. When phosphor paste 470 is cured, phosphor paste 470 is hardened and contracted, thereby forming recess 418 in wavelength converter 405 above recess 408. Accordingly, as illustrated in cross-sectional view (f) of FIG, 18, wavelength conversion element 403 in which recess 418 is formed in wavelength converter 405 is manufactured.

Although wet etching is used in the present embodiment as an example of a method for forming recess 408, the method for forming recess 408 is not limited to such an example. As the method for forming recess 408, for example, dry etching or cutting may be used. The method for forming recess 408 is appropriately selected according to the material used for support member 404.

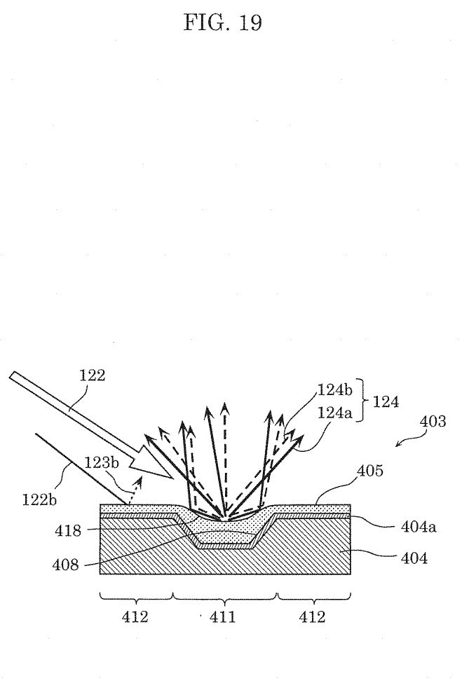

Next, an operation and effect of wavelength conversion element 403 according to the present embodiment will be described with reference to FIG. 19.

FIG. 19 schematically illustrates an operation of wavelength conversion element 403 according to the present embodiment.

As illustrated in FIG. 19, in wavelength conversion element 403 according to the present embodiment, main light 122 emitted from the semiconductor light-emitting element and formed by converging optical system enters first wavelength conversion region 411 of wavelength converter 405.

Here, the surface of wavelength converter 405 in first wavelength conversion region 411 has recess 418, and thus, a portion of outgoing light 124 emitted from recess 418 of wavelength converter 405 is reflected by the surface of recess 418. More specifically, scattered light 124a of main light 122 and fluorescence 124b obtained by the wavelength conversion of main light 122 which are included in outgoing light 124 can be reflected by the surface of recess 418. Accordingly, outgoing light 124 is converged, and thus, wavelength conversion element 403 according to the present embodiment can increase the directivity of outgoing light 124. Specifically, wavelength converter 405 of wavelength conversion element 403 according to the present embodiment can emit outgoing light 124 having a directivity higher than the directivity of outgoing light emitted from a wavelength converter having a flat surface.

Moreover, even if third auxiliary light 122b which is different from main light 122 is generated by the semiconductor light-emitting element or converging optical system, third auxiliary light 122b enters second wavelength conversion region 412 formed in the surrounding region of first wavelength conversion region 411. The wavelength of third auxiliary light 122b can be converted in second wavelength conversion region 412. However, the intensity of third auxiliary light 122 is low, and is, for example, approximately 1/100 of the intensity of main light 122. Moreover, the wavelength conversion efficiency in second wavelength conversion region 412 is lower than the wavelength conversion efficiency of first wavelength conversion region 411. Therefore, the intensity of third outgoing light 123b generated by third auxiliary light 122b is sufficiently less than the intensity of outgoing light 124.

As described above, in wavelength conversion element 403 according to the present embodiment, the thickness of wavelength converter 405 in second wavelength conversion region 412 is less than the thickness of wavelength converter 405 in first wavelength conversion region 411. Hence, outgoing light (stray light) generated by third auxiliary light 122b can be reduced.

Moreover, since first wavelength conversion region 411 can reduce the radiation angle (light distribution characteristics) of outgoing light 124, it is possible to increase the use efficiency of light and the design flexibility of a projection optical system. For example, it is possible to reduce the size of the reflector or lens in the projection optical system.

### Variation 1 of Embodiment 4

Next, a wavelength conversion element according to Variation 1 of Embodiment 4 will be described. The wavelength conversion element according to the present variation is different from wavelength conversion element 403 according to Embodiment 4 in that a light attenuator is included. Hereinafter, the wavelength conversion element according to the present variation will be described focusing on the differences from wavelength conversion element 403 according to Embodiment 4, with reference to the drawings.

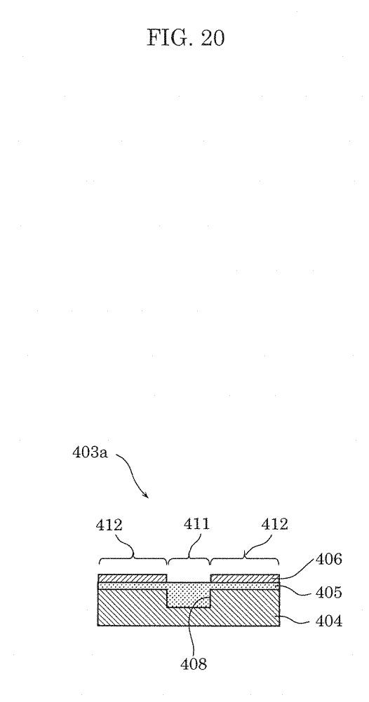

FIG. 20 is a schematic cross-sectional view of a schematic configuration of wavelength conversion element 403a according to the present variation.

As illustrated in FIG. 20, wavelength conversion element 403a according to the present variation includes support member 404 having recess 408 and wavelength converter 405, in a similar manner to wavelength converter 403 according to Embodiment 4. Wavelength conversion element 403a further includes light attenuator 406. Light attenuator 406 has an opening at a position corresponding to recess 408 of support member 404. The region corresponding to the opening is first wavelength conversion region 411, and the surrounding region is second wavelength conversion region 412.

With this configuration, it is possible to adjust the wavelength conversion efficiency relative to excitation light in second wavelength conversion region 412 of wavelength conversion element 403 by adjusting the characteristics of light attenuator 406.

### Embodiment 5

Next, a wavelength conversion element and a light source device according to Embodiment 5 will be described. The light source device according to the present embodiment is different from light source device 100 according to Embodiment 1 in that a converging optical system includes an optical fiber and in that light emitted from the semiconductor light-emitting element enters the wavelength conversion element after propagating through the optical fiber. Moreover, the wavelength conversion element according to Embodiment 5 is the same as the wavelength conversion element according to Embodiment 2 in that the thickness of the wavelength converter is different between the first wavelength conversion region and the second wavelength conversion region. However, the detailed configuration of the wavelength converter according to Embodiment 5 is different from the detailed configuration of the wavelength converter according to Embodiment 2. Hereinafter, the light source device according to the present embodiment will be described focusing on the differences from light source devices 100 and 200 according to Embodiments 1 and 2, with reference to the drawings.

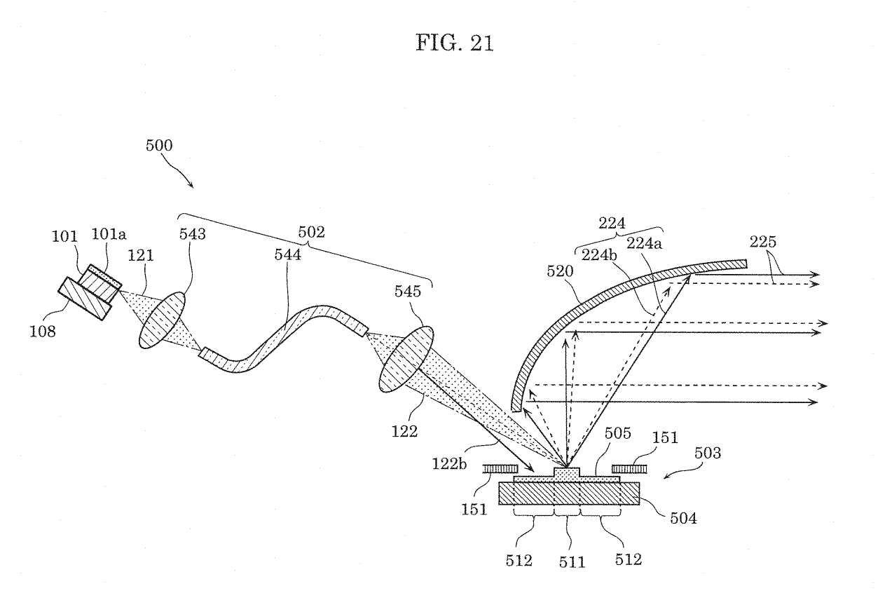

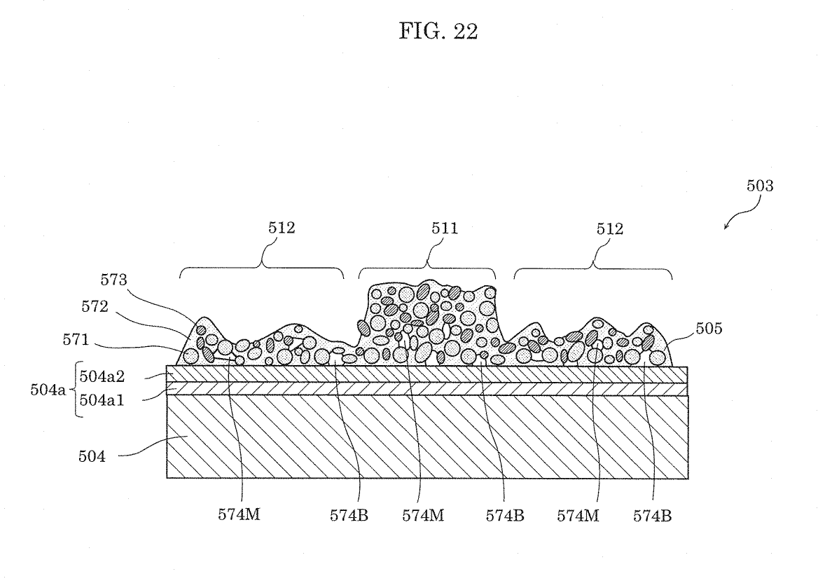

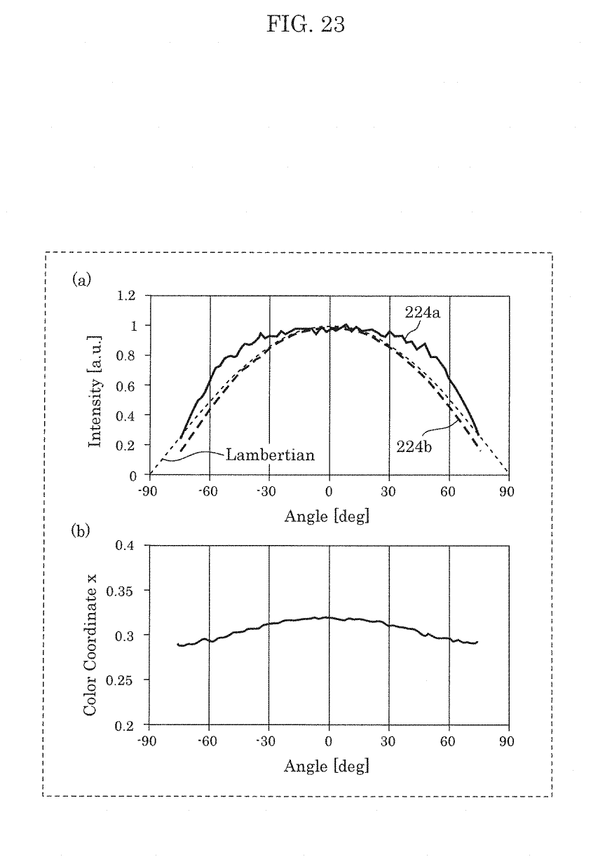

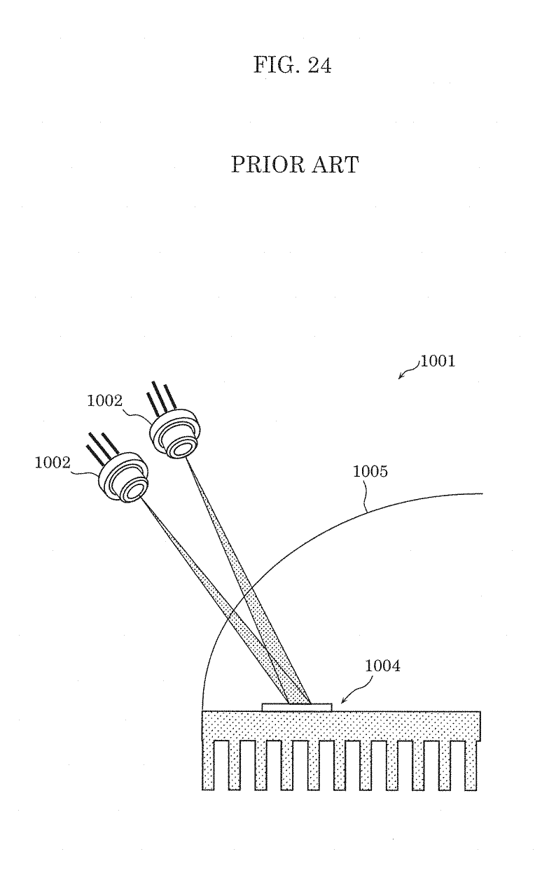

FIG. 21 is a cross-sectional view of a configuration of light source device 500 according to the present embodiment. FIG. 22 is a schematic cross-sectional view of a detailed configuration of wavelength conversion element 503 mounted in light source device 500 according to the present embodiment. In a similar manner to FIG. 12A and the like, FIG. 21 illustrates a cross section which passes near the center of wavelength conversion element 503 and which is vertical to the main face of support member 504. FIG. 23 illustrates the characteristic evaluation results of outgoing light 224 emitted from wavelength conversion, element 503 mounted in light source device 500 according to the present embodiment. FIG. 23 indicates the emission angle dependence of the intensity of outgoing light 224.

### 15-1. Configuration

Light source device 500 includes semiconductor light-emitting element 101, converging optical system 502, and wavelength conversion element 503. Converging optical system 502 includes lens 543, optical fiber 544 through which main light 122 propagates, and lens 545.

Semiconductor light-emitting element 101 is mounted on support member 108 which is, for example, a package, and emits excitation light 121 which is laser light having a peak wavelength of 450 nm, for example, from optical waveguide 101a of semiconductor light-emitting element 101.

Wavelength conversion element 503 includes support member 504, and wavelength converter 505 disposed on support member 504. Wavelength conversion element 503 includes first wavelength conversion region 511 in the central portion, and second wavelength conversion region 512 in the surrounding region of first wavelength conversion region 511. The thickness of wavelength converter 505 is less in second wavelength conversion region 512 than in first wavelength conversion region 511. Light shielding cover 151 having an opening is disposed on the side of wavelength conversion element 503 where main light 122 enters. Light shielding cover 151 is fixed so as to cover the peripheral portion of second wavelength conversion region 512 of wavelength conversion element 503.

Moreover, light projecting member 520, such as a parabolic mirror, is disposed on the side of wavelength conversion element 503 where main light 122 enters.

FIG. 22 illustrates a more detailed configuration of a cross-section of wavelength conversion element 503. Support member 504 is, for example, a substrate such as a silicon substrate or an aluminum nitride ceramic substrate, Optical film 504a which reflects visible light is formed on the surface of support member 504. Optical film 504a is a single layer or multilayer film. In the present embodiment, optical film 504a includes first optical film 504a1 and second optical film 504a2. First optical film 504a1 is, for example, a reflective film made of a metal film of Ag, Ag alloy, or Al. Second optical film 504a2 also has a function of protecting first optical film 504a1 from oxidation or the like, and is made of one or more dielectric layers of, for example, SiO₂, ZnO, ZrO₂, Nb₂O₅, Al₂O₃, TiO₂, SiN, and AlN.

In the present embodiment, wavelength converter 505 includes a mixture of phosphor particles 571 made of YAG:Ce, binder 572 for fixing phosphor particles 571 to second optical film 504a2, and fine particles 573. Wavelength converter 505 further includes voids 574M and 574B.

### 5-2. Operation

In the present embodiment, excitation light 121 enters wavelength conversion element 503 from the wavelength converter 505 side, and outgoing light is emitted from the same wavelength converter 505 side. Specifically, excitation light 121 emitted from optical waveguide 101a is converged by lens 543, enters optical fiber 544, and propagates through optical fiber 544. Main light 122 emitted from optical fiber 544 is again converged by lens 545 and is converged by wavelength conversion element 503.

Here, in light source device 500, main light 122 is emitted to the surface of first wavelength conversion region 511 of wavelength converter 505 obliquely from lens 545 of converging optical system 502. A portion of main light 122 which is blue laser light is diffused on the surface of first wavelength conversion region 511 and inside first wavelength conversion region 511. Another portion of main light 122 is converted into fluorescence by phosphor particles 571 of first wavelength conversion region 511, and is emitted from the surface of first wavelength conversion region 511. Mixed light of scattered light 224a and fluorescence 224b which are diffused and emitted is emitted as outgoing light 224 toward light projecting member 520. Outgoing light 224 is reflected by light projecting member 520, becomes projection light 225 which is substantially parallel light, and is emitted to the outside light source device 500.

Here, third auxiliary light 122b generated by any one of the components of converging optical system 502 is emitted to second wavelength conversion region 512. However, the wavelength conversion efficiency in second wavelength conversion region 512 is lower than the wavelength conversion efficiency in first wavelength conversion region 511. Therefore, it is possible to reduce outgoing light (stray light) generated by third auxiliary light 122b which is the excitation light entering second wavelength conversion region 512.

Light source device 500 further includes light shielding cover 151 so as to cover the peripheral portion of second wavelength conversion region 519. As light shielding cover 151, for example, an aluminum plate having a surface subjected to alumite treatment is used. Accordingly, by causing the secondary light reaching the outer side of second wavelength conversion region 512 to be emitted to the surface of light-shielding cover 151, most of the secondary light can be absorbed.

in the present embodiment, a portion of converging optical system 502 is made of optical fiber 544. Therefore, the positional relationship between semiconductor light-emitting element 101 and wavelength conversion element 503 can be freely set. Therefore, configuring a light projecting device including light source device 500 according to the present embodiment allows more flexible design.

### 5-3. Specific Example and Effect of Wavelength Conversion Element

Hereinafter, a specific example of wavelength conversion element 503 will be described. In the present embodiment, wavelength converter 505 includes, as phosphor particles 571, (Yₓ,Gd₁₋ₓ)₃(Al_{y}Ga_{1-y})₅O₁₂:Ce (0.5≤x≤1, 0.5≤y≤1) or (LaₓY₁₋ₓ)₃Si₆N₁₁:Ce³⁺(0≤x≤1) having an average particle diameter of at least 1 μm and at most 30 μm and a thermal conductivity of approximately 10 W/(m·K). Wavelength converter 505 includes, as binder 572 for fixing phosphor particles 571, a transparent material mainly made of silsesquioxane having a thermal conductivity of approximately 1 W/(m·K).

When phosphor particles 571 are defined as first particles, wavelength converter 505 further includes, as second particles, fine particles of Al₂O₃ having an average particle diameter of at least 0.1 μm and at most 10 μm and a thermal conductivity of approximately 30 W/(m·K). Here, the second particles are mixed with wavelength converter 505 with the ratio of at least 10 vol % and at most 90 vol % with respect to phosphor particles 571. With this configuration, the ratio of phosphor particles 571 per unit area in wavelength converter 505 in first wavelength conversion region 511 can be reduced and the thickness of wavelength converter 505 can be increased in comparison with the wavelength converter including the same content of phosphor particles and no second particles. Therefore, the thickness of first wavelength conversion region 511 in wavelength converter 505 can be easily increased. It is possible to differentiate the conversion efficiencies by increasing the difference in thickness between first wavelength conversion region 511 and second wavelength conversion region 512, and thus, the influence of third auxiliary light 122b on the projection image can be reduced. Here, the thickness of first wavelength conversion region 511 is increased not by increasing the binder having a relatively low thermal conductivity, but by increasing the content of the second particles having a higher thermal conductivity. Hence, the heat generated in first wavelength conversion region 511 can be radiated easily to the support member. Therefore, it is possible to reduce the performance degradation such as a reduction in light emission efficiency in first wavelength conversion region 511.

Moreover, as the second particles, 1203 is used which has a refractive index of 1.8 and which has a large difference in refractive index from silsesquioxane having a refractive index of 1.5. Accordingly, it is also possible to increase the scattering properties of the excitation light in second wavelength conversion region 512 having thin wavelength converter 505. Hence, it is possible to reduce the luminous intensity of light emitted from second wavelength conversion region 512 per unit emitting angle.

Moreover, voids 574M and 574B may be disposed inside wavelength converter 505. In the present embodiment, voids 574M are formed near the central portion of wavelength converter 505 and voids 574B are formed near the interface between wavelength converter 505 and optical film 504a.

In the present embodiment, wavelength converter 505 is formed so that the density of voids 574M and 574B (that is, the component ratio) increases as the distance to optical film 204a decreases, With this configuration, the excitation light entering the inside of wavelength converter 505 can be extracted from light source device 500 by more efficiently scattering the excitation light by voids 574M and 574B having a large refractive difference from binder 572 and the like. Moreover, since voids 574B contact second optical film 504a2 which is a dielectric, it is possible to efficiently scatter the excitation light and fluorescence while reducing the energy loss caused by the metal surface.

As described in Embodiment 1, voids 574M and 574B described above can be easily formed by forming wavelength converter 505 using a phosphor paste including a mixture of phosphor particles 571 made of YAG:Ce and binder 572 made of polysilsesquioxane. Specifically, a paste film is formed on support member 504. The paste film is made of a phosphor paste in which phosphor particles 571 and the second particles are mixed into binder 572 in which polysilsesquioxane is dissolved in an organic solvent. Subsequently, high-temperature annealing is performed at approximately 200° C. to vaporize the organic solvent in the paste film. Here, the organic solvent vaporized from the portion of wavelength converter 505 near support member 504 can be easily held by wavelength converter 505, and thus, voids 574M and 574B can be easily formed. With such a manufacturing method, it is possible to easily form voids near optical film 204a at a high density. With the above manufacturing method, it is possible to form the first wavelength conversion region and the second wavelength conversion region including wavelength converters 505 having different thickness, by applying a phosphor paste a plurality of times using the opening masks having openings of different sizes.

First wavelength conversion region 511 of wavelength converter 505 thus configured also provides the advantageous effects as described below. Graph (a) of FIG. 23 illustrates emission angle dependence of the light intensity of light having a wavelength corresponding to scattered light 224a and light having a wavelength corresponding to fluorescence 224b relative to the direction orthogonal to the surface where excitation light 121 enters (upward normal direction in FIG. 21). It is understood that scattered light 224a obtained by using wavelength conversion element 503 described in the present embodiment is the light radiated after excitation light 121 is sufficiently scattered. In particular, in the region where the emission angle is large, such a distribution is achieved in which the light intensity ratio with respect to the normal direction is greater than a Lambertian distribution represented by cos θ. In a light source device having such a distribution, as illustrated in graph (b) of FIG. 23, the angle distribution of the chromaticity of outgoing light 224 including scattered light 224a and fluorescence 224b can be set such that chromaticity x decreases as the emission angle increases. In other words, such a light distribution can be realized that the correlated color temperature increases as the emission angle of the outgoing light increases. By using a light source device having such a light distribution, it is possible to realize a light projection device which can increase the correlated color temperature of the total luminous flux while setting the color temperature at the angle near 0 degrees, that is, at the emission center, to the chromaticity at which the luminous factor is high. Note that such a light source device having the light distribution above can be realized by (i) forming wavelength converter 505 including phosphor particles made of, for example, YAG:Ce having an average particle diameter of 2 μm to 10 μm, second particles made of Al₂O₃ having an average particle diameter of 1 μm to 4 μm, and a binder made of silicone or polysilsesquioxane having a refractive index of 1.5 or less, and (ii) setting the volume ratio of the binder to range from 20% to 50% relative to the volume of wavelength converter 505. In the range where the film thickness of wavelength converter 505 on support member 504 is at least 20 μm and at most 50 μm, outgoing light can be realized having a correlated color temperature of 5000 K to 6500 K according to the ratio of the light intensity of the scattered light and fluorescence.

Note that in the present embodiment, polysilsesquioxane is used as binder, but the binder is not limited to such an example, For example, it is possible to form more reliable wavelength conversion element 503 by forming a binder using a material mainly including inorganic materials such as SiO₂, Al₂O₃, ZnO, Ta₂O₅, Nb₂O₅, TiO₂, AlN, BN, and BaO. Moreover, the second particles included in wavelength converter 505 are not limited to Al₂O₃, but fine particles of SiO₂, TiO₂ or the like can be selected. In particular, it is possible to increase the light scattering properties of wavelength converter 505 and to efficiently transmit the heat from phosphor particles 571 to support member 504, by mixing fine particles of boron nitride and diamond having a high thermal conductivity. Moreover, phosphor particles 571 are not limited to (Y, Gd)₃(Al, Ga)₅O₁₂:Ce or (La, Y)₃Si₆N₁₁:Ce. It is possible to select any phosphor materials, as described in Embodiment 1, which emit light with desired chromaticity coordinates.

### Other Variations, etc.

Although the light source device and the light projection device according to the present disclosure have been described based on the embodiments and variations, the present disclosure is not limited to the above embodiments and variations.

For example, in each of the embodiments and variations described above, a semiconductor laser is used as a semiconductor light-emitting element. However, the semiconductor light-emitting element is not limited to the semiconductor laser. For example, a light emitting diode may be used as a semiconductor light-emitting element.

Forms obtained by making various modifications to the embodiments and variations that can be conceived by a person skilled in the art as well as forms realized by arbitrarily combining structural elements and functions in the embodiments and variations which are within the scope of the essence of the present disclosure are included in the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure, Accordingly, all such modifications are intended to be included within the scope of the present disclosure.

### INDUSTRIAL APPLICABILITY

The present disclosure can be applied to a wavelength conversion element and a light source device which are used in the field of display, such as a projection display device, or the field of lighting such as industrial lighting and medical lighting.

What is claimed is:

1. A light source device, comprising:
a semiconductor light-emitting element;
a converging optical system which converges excitation light emitted from the semiconductor light-emitting element; and
a wavelength conversion element which includes a wavelength converter to which the excitation light is emitted, the wavelength converter converting at least a portion of a wavelength of the excitation light and emitting light having a converted wavelength,
wherein the wavelength conversion element includes:
a first wavelength conversion region which includes a portion of the wavelength converter, and where main light of the excitation light enters, the main light being converged by the converging optical system; and
a second wavelength conversion region (i) which includes a portion of the wavelength converter other than the portion of the wavelength converter in the first wavelength conversion region, (ii) which is disposed in a surrounding region of the first wavelength conversion region, and (iii) where the excitation light excluding the main light enters, and
the second wavelength conversion region has a wavelength conversion efficiency lower than a wavelength conversion efficiency of the first wavelength conversion region.

2. The light source device according to claim 1,
wherein the wavelength converter includes a phosphor material activated by a rare earth element, and
the phosphor material absorbs at least a portion the excitation and emits fluorescence as the light having the converted wavelength, the fluorescence having a wavelength different from the wavelength of the excitation light.

3. The light source device according to claim 1,
wherein the wavelength converter includes a diffusion material which diffuses the main light.

4. The light source device according to claim 1,
wherein a thickness of the wavelength converter is less in the second wavelength conversion region than in the first wavelength conversion region

5. The light source device according to claim 1,
wherein the wavelength conversion element includes a light attenuator which reduces an amount of light emitted from the second wavelength conversion region.

6. The light source device according to claim 5,
wherein the light attenuator transmits the excitation light, and reflects the light emitted from the wavelength converter and having the converted wavelength.

7. The light source device according to claim 5,
wherein the light attenuator absorbs at least one of the excitation light or the light emitted from the wavelength converter to convert the absorbed light into heat.

8. The light source device according to claim 5,
wherein the light attenuator includes an opening at a position corresponding to the first wavelength conversion region.

9. The light source device according to claim 8,
wherein the opening has a diameter greater than or equal to a spot diameter of the main light on a surface of the wavelength converter where the main light enters.

10. The light source device according to claim 1,
wherein the wavelength conversion element includes a support member having a recess, and
the wavelength converter is disposed in the recess and in a surrounding region of the recess.

11. The light source device according to claim 10,
wherein a surface of a portion of the wavelength converter disposed in the recess is recessed.

12. The light source device according to claim 1,
wherein the converging optical system includes an optical element including a plurality of regions connected by an optically discontinuous interface, and
the main light enters the wavelength converter through the plurality of regions of the optical element.

13. The light source device according to claim 1,
wherein the converging optical system includes an optical fiber through which the main light propagates.

14. The light source device according to claim 1,
wherein the main light enters the wavelength converter obliquely relative to a surface of the wavelength converter.

15. The light source device according to claim 14,
wherein the wavelength conversion element includes, in the second wavelength conversion region, a projection to which the main light reflected by the surface is emitted.
